(19) United States
(12) Patent Application Publication
(10) Pub. No.: US 2026/0349130 A1
(43) Pub. Date: Nov. 5, 2026

(54) SYSTEM AND METHOD FOR HIGH-FREQUENCY REMOTE SURVEYING

(71) Applicant: Barney F. Gorin, Gaithersburg, MD (US)

(72) Inventor: Barney F. Gorin, Gaithersburg, MD (US)

(21) Appl. No.: 19/743,074

(22) Filed: Jul. 15, 2026

Related U.S. Application Data
(63) Continuation-in-part of application No. 19/179,590, filed on Apr. 15, 2025.
(60) Provisional application No. 63/634,124, filed on Apr. 15, 2024.
(60) Provisional application No. 63/634,132, filed on Apr. 15, 2024.

(51) Int. Cl. G01V 1/30; G01V 1/143; G01V 1/16; G01V 1/22

(52) U.S. Cl. CPC G01V 1/301; G01V 1/143; G01V 1/168; G01V 1/223; G01V 1/303; G01V 1/307; G01V 2210/32

(57) ABSTRACT

The present disclosure relates to a system and method for high-frequency remote surveying. The system includes a plurality of penetrometers, each penetrometer functioning as an autonomous computational node and comprising a seismic wave generator configured to generate high-frequency seismic waves, sensors capable of detecting the high-frequency seismic waves, and a control unit configured to broadcast composite waveform data to other penetrometers and calculate seismic properties from data received from neighboring penetrometers. The system further includes a network configured to enable peer-to-peer communication between the plurality of penetrometers without requiring centralized coordination.

### CROSS-REFERENCE TO RELATED APPLICATION

This application is a continuation-in-part of U.S. application Ser. No. 19/179,590 filed Apr. 15, 2025, which claims priority to Provisional Application No. 63/634,124 filed Apr. 15, 2024 and Provisional Application No. 63/634,132 filed Apr. 15, 2024, the entire contents of each of which are hereby incorporated by reference.

### FIELD OF THE INVENTION

This application is related to the field of remote surveying. In particular, the present invention relates to a system and method for large-scale high-frequency remote surveying of inhospitable or hazardous sites using a distributed autonomous sensor mesh architecture.

### BACKGROUND OF THE INVENTION

Remote seismic sensing systems and methods have long been employed to investigate subsurface conditions in various environments. However, these existing technologies often fall short when faced with the challenge of detecting and identifying all types of objects, particularly in inhospitable or expansive areas. Understanding subsurface conditions in such places, whether it's a construction site on the Moon or a minefield on Earth, presents significant difficulties that can be both challenging and dangerous. The limitations of current methodologies become especially apparent when attempting to scale from small, manageable sites to vast areas. For instance, techniques suitable for a construction site in Germany may prove entirely inadequate when applied to an extensive area like Zone Rouge in France.

Conventional remote sensing systems typically rely on lower frequency sensors due to their ability to penetrate deeper into the subsurface and their relative ease of implementation in field conditions. These lower frequency systems are well-suited for detecting larger objects or general subsurface structures over extensive areas. However, they have significant limitations when it comes to identifying smaller objects or providing high-resolution imaging of subsurface conditions. The wavelengths associated with lower frequencies are too large to interact meaningfully with small objects or fine details, resulting in a lack of precision in object detection and characterization. This shortcoming becomes particularly problematic in applications such as detecting unexploded ordnance or conducting detailed geological surveys, where the ability to identify and characterize small objects is crucial. Furthermore, the lower resolution of these systems can lead to ambiguities in data interpretation, potentially missing critical subsurface features or mischaracterizing detected objects. These limitations have long posed challenges for comprehensive and accurate subsurface surveying, especially in hazardous or inhospitable environments where detailed, high-resolution data is essential for safe and effective operations.

This inadequacy is particularly evident in the detection of Explosive Remnants of War (ERWs). Current methods for locating ERWs do not use seismic technology and are not only slow and dangerous, putting human lives at risk, but also inefficient in covering large areas. Existing technologies typically create narrow, linear paths of examined territory rather than sweeping across expansive regions. Some systems even resort to intentionally detonating explosive devices to create narrow paths through minefields, sacrificing careful ordnance removal for expediency. These approaches highlight the pressing need for more advanced, comprehensive, and safer remote sensing solutions capable of addressing the challenges posed by diverse subsurface conditions and potentially hazardous objects across large-scale, inhospitable environments.

Beyond the frequency limitations of conventional systems, existing seismic sensing approaches face additional fundamental challenges. Conventional seismic sensing assumes uniform soil characteristics rather than measuring them locally. When standards or averages of key soil characteristics, such as seismic velocity and attenuation, are assumed to apply across a survey area, poor results follow because these characteristics vary significantly in different soils and at different soil moisture levels. This assumption of uniformity leads to suboptimal sensor spacing and unreliable detection of subsurface anomalies.

Existing remote sensing systems also typically rely on centralized processing architectures where all sensor data must be transmitted to a central facility for computation and analysis. This approach creates bandwidth bottlenecks when scaling to large numbers of sensors, introduces single points of failure that can disable entire survey operations, and limits the system's ability to operate in communications-denied environments. The reliance on centralized infrastructure also restricts deployment options and increases operational complexity.

Furthermore, conventional systems are typically limited to ground vehicle deployment, making them unable to access difficult terrain such as steep slopes, crater-pocked areas, forested regions, or areas with unstable ground. Many of the highest-value survey sites, including heavily contaminated post-conflict zones, present exactly these types of terrain challenges. The inability to deploy sensors in such environments significantly limits the applicability of existing technologies.

Additionally, detecting small subsurface objects requires the ability to extract weak reflected signals from background noise. Existing systems lack adequate stimulus events for signal processing techniques to achieve the signal-to-noise ratios necessary for reliable detection of small objects at useful distances. Without methods to enhance weak signals through statistical aggregation or other techniques, conventional systems cannot achieve the detection sensitivity required for applications such as locating small unexploded ordnance.

Furthermore, conventional systems rely on factory or pre-deployment instrument calibration that cannot account for in-field scale-factor drift across the sensor population of an array. Without an in-field calibration reference that is traceable to a physical standard, multi-channel deployments accumulate inter-sensor amplitude errors that limit the precision of spatial attenuation and surface-wave dispersion measurements.

Accordingly, there is a need for a detailed remote seismic surveying system that overcomes these and other challenges, including the need to measure local soil characteristics in real-time, operate with distributed processing architectures that are scalable and fault-tolerant, deploy sensors across diverse and difficult terrain, create a custom sensor array for every site, and detect weak signals from small subsurface objects. Such a system should be able to search an inhospitable site at scale, safely, economically, effectively, and efficiently.

### SUMMARY

Examples of the present disclosure provide systems and methods for high-frequency remote surveying.

According to a first aspect of the present disclosure, a system for high-frequency remote surveying is provided. The system can include a plurality of penetrometers, each penetrometer functioning as an autonomous computational node. Each penetrometer can include a seismic wave generator configured to generate high-frequency seismic waves, sensors capable of detecting the high-frequency seismic waves, a control unit configured to broadcast composite waveform data to other penetrometers and calculate seismic properties from data received from neighboring penetrometers, and a battery for powering the penetrometer. The system can also include a network configured to enable peer-to-peer communication between the plurality of penetrometers without requiring centralized coordination.

According to a second aspect of the present disclosure, a method for high-frequency remote surveying is provided. The method can include deploying a plurality of penetrometers across a survey area, each penetrometer functioning as an autonomous computational node. The method can further include generating, at a source penetrometer, multiple seismic impacts at known times. The method can also include generating, at each receiving penetrometer, composite waveforms by statistically aggregating sensor data across the multiple seismic impacts. The method can, in addition, include broadcasting, from each penetrometer, composite waveform data to other penetrometers via peer-to-peer communication. The method can also include autonomously calculating, at each penetrometer, seismic properties from data received from neighboring penetrometers.

According to a third aspect of the present disclosure, a method for high-frequency remote surveying is provided. The method may be implemented on a system for high-frequency remote surveying. The method may include deploying a plurality of penetrometers across a survey area at precisely measured positions, each penetrometer comprising a seismic wave generator and sensors. The method may further include generating, at a source penetrometer, multiple seismic impacts at known times using GPS-synchronized timing. In some embodiments, the seismic source is external to the penetrometers—for example, a hammer-driven plate coupled to the ground surface-rather than a generator integral to a penetrometer, the system using the external source provided its timing and location are known. The method may also include time-aligning, at each receiving penetrometer, sensor data from the multiple seismic impacts using the GPS-synchronized timing. The method may, in addition, include statistically aggregating the time-aligned sensor data to generate composite waveforms with improved signal-to-noise ratio. The method may also include extracting parameters from the composite waveforms, the parameters comprising wave arrival time, amplitude, frequency content, and temporal attenuation. The method may further include transmitting the extracted parameters rather than raw sensor data to avoid bandwidth bottlenecks when scaling to large numbers of penetrometers.

According to a fourth aspect of the present disclosure, a method for high-frequency remote surveying is provided. The method may be implemented on a system for high-frequency remote surveying. The method may include deploying a plurality of penetrometers across a survey area, each penetrometer comprising a seismic wave generator and sensors. The method may further include generating, at a source penetrometer, multiple seismic impacts at known times using Real Time Kinematic (RTK) GPS position measurements. The method may also include position-aligning, at each receiving penetrometer, sensor data from the multiple seismic impacts using the RTK GPS-position. The method may, in addition, include statistically aggregating the position-aligned sensor data to generate composite waveforms with improved position knowledge. The method may also include extracting parameters from the composite waveforms, the parameters comprising propagation velocity and relative position. The RTK GPS precision enables precision propagation velocity calculations and improved spatial attenuation calculations. The method may further include transmitting the extracted parameters rather than raw sensor data to avoid bandwidth bottlenecks when scaling to large numbers of penetrometers.

According to a fifth aspect of the present disclosure, a penetrometer for high-frequency remote surveying is provided. The penetrometer may include a housing. The penetrometer may further include a seismic wave generator comprising an internal recoilless hammer configured to generate high-frequency seismic waves. The penetrometer may also include sensors capable of detecting the high-frequency seismic waves, the sensors comprising at least one of an accelerometer, a geophone, or a microphone. The penetrometer may, in addition, include a global navigation satellite system (GNSS) receiver configured to provide precise timing and location. The penetrometer may also include a control unit configured to generate composite waveforms by statistically aggregating sensor data across multiple seismic impacts, calculate seismic properties, and communicate with other penetrometers via peer-to-peer communication. The penetrometer may further include a battery for powering the penetrometer.

These and other aspects and advantages will become apparent to those of ordinary skill in the art by reading the following detailed description, with reference where appropriate to the accompanying drawings. Further, it should be understood that the foregoing summary is merely illustrative and is not intended to limit in any manner the scope or range of equivalents to which the appended claims are lawfully entitled.

### BRIEF DESCRIPTION OF THE DRAWINGS

The accompanying drawings, which are incorporated in and constitute a part of this specification, illustrate examples consistent with the present disclosure and, together with the description, serve to explain the principles of the disclosure.

FIG. 1 is a block diagram of a system for high-frequency remote surveying, according to an example of the present disclosure.

FIG. 2 is a block diagram of a penetrometer, according to an example of the present disclosure.

FIG. 3A is a block diagram of a penetrometer, according to an example of the present disclosure.

FIG. 3B is a block diagram of a penetrometer, according to another example of the present disclosure.

FIG. 4A is a block diagram of a mounting interface for a penetrometer, according to an example of the present disclosure.

FIG. 4B is a block diagram of another mounting interface for a penetrometer, according to another example of the present disclosure.

FIG. 4C is a block diagram of another mounting interface for a penetrometer, according to another example of the present disclosure.

FIG. 5A is a block diagram of a penetrator interface for a penetrometer, according to an example of the present disclosure.

FIG. 5B is a block diagram of another penetrator interface for a penetrometer, according to another example of the present disclosure.

FIG. 5C is a block diagram of another penetrator interface for a penetrometer, according to another example of the present disclosure.

FIG. 6 is an illustration of a mobile vehicle for delivering penetrometers, according to an example of the present disclosure.

FIG. 7 is a seismic energy diagram, according to an example of the present disclosure.

FIG. 8 is a block diagram of a distributed mesh architecture, according to an example of the present disclosure.

FIG. 9 is a block diagram of a computing system, according to an example of the present disclosure.

FIG. 10 is a flow chart illustrating a method for high-frequency remote surveying, according to an example of the present disclosure.

### DETAILED DESCRIPTION

While the present invention is capable of being embodied in various forms, for simplicity and illustrative purposes, the principles of the invention are described by referring to certain embodiments thereof. It is understood, however, that the present disclosure is to be considered as an exemplification of the claimed subject matter and is not intended to limit the appended claims to the specific embodiments illustrated. It will be apparent to one of ordinary skill in the art that the invention may be practiced without limitation to these specific details. In other instances, well-known methods and structures have not been described in detail so as not to unnecessarily obscure the invention. For example, while embodiments herein are described with reference to high-frequency remote surveying, it is understood that the systems and methods may be implemented similarly with respect to remote surveying more generally.

The terminology used in the present disclosure is for the purpose of describing particular embodiments only and is not intended to limit the present disclosure. As used in the present disclosure and the appended claims, the singular forms “a,” “an,” and “the” are intended to include the plural forms as well, unless the context clearly indicates otherwise. It shall also be understood that the terms “and” and “or” used herein is intended to signify and include any or all possible combinations of one or more of the associated listed items. As used herein, the term “if” may be understood to mean “when” or “upon” or “in response to a judgment” depending on the context.

The present disclosure relates to high-frequency remote surveying. As used herein, “high-frequency” refers to the seismic band employed by the system, on the order of tens of hertz to a few kilohertz, and not to electromagnetic frequencies. In one or more embodiments, the high-frequency remote surveying system is used for large-scale surveying. Conventional systems assume uniform soil characteristics rather than measuring them locally, rely on centralized processing that creates bandwidth bottlenecks and single points of failure, and cannot adequately extract weak signals from background noise. The disclosed system overcomes these challenges through a distributed autonomous sensor mesh architecture in which penetrometers function as autonomous computational nodes capable of peer-to-peer communication and computation without requiring centralized coordination. The system employs temporal oversampling with statistical aggregation of as many hammer impacts as are of value to dramatically improve signal-to-noise ratios, enabling detection of weak subsurface signals that would otherwise be indistinguishable from noise. Real-time hyperlocal seismic property measurement with continuous recalculation achieves velocity precisions enabling detection of small anomalies.

In one or more embodiments, the system is configured to detect unexploded ordnance of varying dimensions based on seismic frequency. Unexploded ordnance dimensions vary greatly—for example, a hand grenade may be approximately 64 mm in diameter and 89 mm long, a 60 mm mortar shell approximately 60×300 mm, and a 155 mm artillery round approximately 155×750 mm. Detection capability depends on the relationship between ordnance dimension and seismic wavelength, with higher frequencies enabling detection of smaller objects. Testing has demonstrated that at frequencies of 360 Hz and above, the long dimension of 60 mm mortar shells becomes detectable, and at 140 Hz and above, 155 mm artillery rounds become detectable along their long dimension.

The fault-tolerant architecture scales to 100 or more penetrometers, continues operating despite loss of individual nodes, and enables operation in communications-denied environments. Multi-modal deployment flexibility through platform-agnostic penetrometer design with self-righting capability enables sensor placement via aerial vehicles, ground vehicles, watercraft, or manual installation, providing access to difficult terrain inaccessible to conventional ground-vehicle-only systems. This distributed approach enables comprehensive subsurface investigation across vast or inhospitable areas while detecting objects spanning multiple orders of magnitude in size through dual-wave detection of both high-frequency P-waves for landmine-scale resolution and lower-frequency S-waves for larger unexploded ordnance. In one or more embodiments, the system is used for identifying Explosive Remnants of War (ERW), such as unexploded ordnance, land mines, or improvised explosive devices, which continue to pose significant dangers in post-conflict zones such as the Zone Rouge in France.

In one or more embodiments, the remote surveying system uses the penetrometers' on-board seismic sources, instrumentation, and computing power to calculate the local soil's seismic properties between each pair of penetrometers. By placing two penetrometers at known locations and with both having access to precise timing and position signals and commanding one to generate a seismic stimulus, the system can calculate the soil's seismic propagation velocity and spatial attenuation coefficient. The seismic wave velocity is critical to calculating the size of an anomaly detectable by a specific frequency. For example, if the seismic velocity is 200 meters per second and the frequency is 2,000 Hz, the smallest detectable anomaly would be 0.1 meters, or 10 centimeters, in any dimension. These properties also include the soil's seismic wave attenuation characteristics as a function of both distance and of frequency. The on-board system can calculate a maximum distance a detectable seismic wave of a particular frequency may travel using those attenuation characteristics with the seismic stimulus output power, the instrumentation sensitivity, and the signal to noise enhancement from added stimulus events. In one or more embodiments, placement of penetrometers is approximate, but the precise location is known because of the RTK GPS.

In one or more embodiments, the remote surveying system generates a map of the survey site showing penetrometer locations together with the calculated soil parameters between penetrometers, and as interpolated between calculated locations.

In one or more embodiments, the remote surveying system uses the map of the survey site to generate a penetrometer array configuration for maximum penetrometer spacing, or high productivity, while also meeting minimum size object detection goals within the limits of the local soil's seismic characteristics and penetrometer capabilities. This may be achieved through the “round trip” distance a wave must travel from the penetrometer to the object to the penetrometer or the “one way distance” from the penetrometer to the object to a second penetrometer.

In one or more embodiments, the remote surveying system continuously adjusts the penetrometer array configuration to accommodate new information. Potential anomalies might be designated for additional investigation by adding penetrometers to the array closer to the potential anomaly, for example.

In one or more embodiments, the remote surveying system samples sensor data at a rate from approximately 1 Hz up to approximately 60,000 Hz, the rate being selected to satisfy a Nyquist criterion for the highest frequency of interest in the seismic waves, and operates on seismic wave frequency content from approximately 10 Hz up to approximately 2,000 Hz, with the band from approximately 100 Hz to approximately 1,000 Hz containing observed soil-property signatures including frequency-dependent attenuation and layer-resonance features. For instance, a 250 Hz spectral feature has been observed at sensor distances of 3 to 7 meters in cohesive soils, and coherent seismic energy up to approximately 900 Hz has been observed at distances up to 7 meters with stacking of approximately 5 hammer impacts. This frequency provides acceptable readings for detecting anomalies while balancing penetration depth and resolution. The effective distance for a given frequency depends on the local soil's seismic velocity and attenuation characteristics, which can be measured using two penetrometers. By placing two penetrometers at known locations and having one generate a seismic stimulus, the system can calculate the soil's seismic velocity and attenuation coefficients. These parameters are used for optimizing penetrometer spacing and interpreting the received signals.

For higher frequency sensing, the system employs more sophisticated techniques. This involves using a high-power, directional seismic source in one penetrometer, aimed towards another. Unlike the broadband energy produced by a hammer impact, this source concentrates energy at a single frequency, similar to a loudspeaker but for seismic waves. This approach allows for higher resolution imaging but over shorter distances. The system dynamically adjusts penetrometer locations based on the expected size of potential threats and the desired survey productivity.

The precise timing and location data from each penetrometer, combined with advanced edge processing capabilities, enable the calculation of several critical parameters. These include the time-of-flight of seismic waves between penetrometers, which is used to compute soil velocity; the amplitude decay of waves over distance, used to determine the attenuation coefficient; and the precise location and characteristics of subsurface anomalies. For example, if a seismic wave takes 10 milliseconds to travel between two penetrometers spaced 2 meters apart, the system can calculate a nominal soil velocity of 200 m/s which would include some uncertainty for the first calculation. Additional measurements would quickly resolve the soil velocity to a precise value. Actual soil seismic velocities are expected to fall within a general range from 100 to 250 m/s.

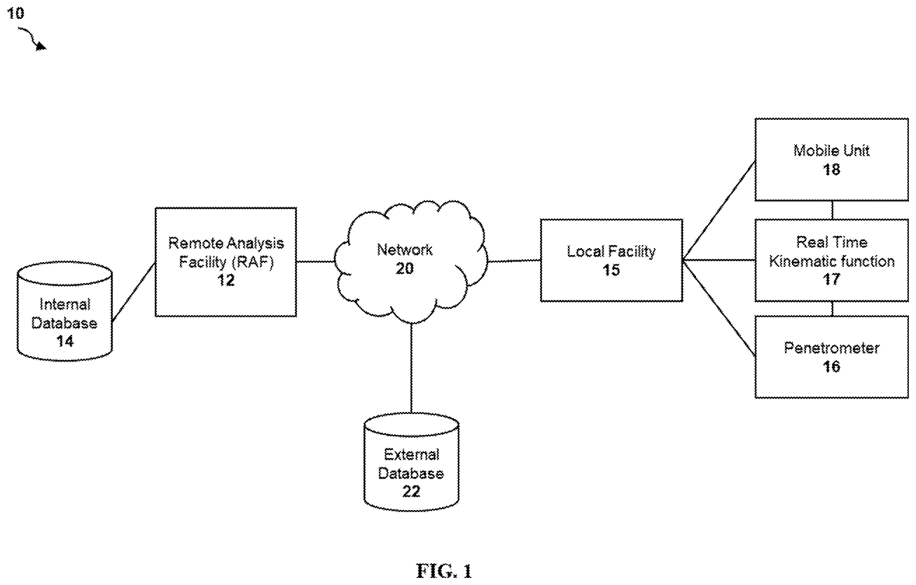

Turning now to the figures, FIG. 1 shows a remote surveying system 10, according to an embodiment of the present disclosure. The remote surveying system 10 includes a remote analysis facility (RAF) 12 with an internal database 14, local facility 15, at least one penetrometer 16, a Real Time Kinematic (RTK) function 17, a mobile unit 18, a network 20, and an external database 22. The RTK function 17 is an off-the-shelf item that enables GPS position measurements to centimeter accuracy. The RTK function 17 sends signals to the local facility 15, the mobile unit 18, and the penetrometer 16. By stacking RTK GPS measurements, the system gains additional position precision that improves penetrometer position accuracy. The RAF 12 is able to communicate with the local facility 15 and external database 22 through the network 20. The local facility 15 can communicate with the penetrometer 16 and mobile unit 18 through wireless communication or a local wireless network. The RAF 12 can be a remote central analysis and control system or part of a cloud platform that runs software for extended analysis of the surveying data.

The local facility 15 serves as an on-site operational hub for the remote surveying system 10. Located in proximity to the area being surveyed, it acts as an intermediary between the RAF 12 and the field equipment, including the penetrometers 16 and mobile units 18. The local facility 15 is equipped with local computing power such as a high-performance server or small cluster of computers capable of near real-time data processing, temporary data storage, and running complex algorithms for initial data analysis. The initial data analysis performed at the local facility 15 may include reconstructing one or more subsurface property distributions—such as seismic velocity, acoustic impedance, density, attenuation, or scattering strength—from the wavefields recorded by the penetrometers 16, using computational methods including, without limitation, forward modeling of elastic wave propagation together with one or more inverse methods such as full-waveform inversion, travel time or waveform tomography, and diffraction tomography. The local facility 15 may further apply spectral and resonance-scattering analysis and one or more pattern-recognition or machine-learning classifiers to discriminate and identify subsurface anomalies, it being understood that the particular method, frequency content, and parameters are selected according to site conditions and are not limited to any specific values. The computing resources at the local facility enable it to perform tasks such as data compression, noise filtering, and preliminary anomaly detection, reducing the amount of raw data that needs to be transmitted to the RAF 12. This local processing capability also allows for rapid decision-making in response to field conditions, such as adjusting penetrometer placement or mobile unit paths based on initial and ongoing findings. The local facility 15 further includes communication systems that allow it to receive instructions from the RAF 12 via the network 20 and relay these commands to the field equipment using wireless communication or a local wireless network. It also collects and preprocesses data from the penetrometers 16 and mobile units 18 before transmitting it back to the RAF 12 for comprehensive analysis. This local facility can house maintenance equipment, spare parts, and potentially a team of technicians to manage and service the field equipment, ensuring continuous and efficient operation of the surveying system. By having this local presence, the system can respond quickly to changing conditions without requiring constant direct communication between the field equipment and the distant RAF 12.

The RAF 12 is the operational hub of the remote surveying system, integrating advanced data processing capabilities with human oversight functions. Located in a secure facility away from hazardous survey areas, the RAF houses powerful computing resources, sophisticated analysis software, and operator workstations. It receives raw and processed data from all field deployed penetrometers across all search sites and further processes that data, utilizing processes and algorithms to detect, characterize, and precisely locate subsurface objects. The RAF coordinates the overall survey strategy. By combining automated analysis with human decision-making capabilities, the RAF enables efficient, safe, and accurate subsurface surveying across large areas, while maintaining the flexibility to adapt to complex scenarios that require human judgment. The RAF communicates with an internal database 14 that stores and manages vast amounts of data gathered from penetrometers, survey area characteristics, outside sources such as combat records or unit histories, detailed descriptions of various types of ordnance and landmines, satellites, and operational parameters. This database not only archives raw sensor data but also supports the system's processing algorithms, storing intermediate results, and analysis outputs. By leveraging this comprehensive data repository, the RAF can perform real-time analysis, historical comparisons, and predictive modeling to enhance the accuracy and efficiency of the survey process.

In one or more embodiments, the RAF is configured to train an artificial intelligence application on field data comprising objects of known type, size, orientation, and position. The training data comprises extensive field measurements, potentially numbering in the thousands, collected with and without objects present, with each object carefully measured and positioned. The training data is documented in a database correlating seismic signatures with ground truth information. The system iteratively improves as each subsequent test adds to the database with ground truth for what was done and what was found. The system outputs probability assessments for detected anomalies, such as a probability that a detected anomaly is a specific object type with a specific orientation, for incorporation into the Digital Twin. Because soil characteristics vary significantly from place to place, the training is conducted across diverse soil types and geographic locations.

The penetrometer 16 is a sophisticated sensing device that serves as the primary data collection tool in the remote surveying system 10. Designed for insertion into the ground at predetermined locations across the survey area, the penetrometer combines multiple functions in a single, modular unit. It includes a dynamic penetration mechanism, featuring an internal recoilless hammer that drives the device into the soil while simultaneously generating seismic waves. The penetrometer is equipped with an array of high-sensitivity sensors, including accelerometers, geophones, and microphones, capable of detecting seismic wave frequency content from approximately 10 Hz to approximately 2,000 Hz, with the sensors being sampled at rates from approximately 1 Hz up to approximately 60,000 Hz. This would allow for the detection and characterization of very small objects. As it penetrates the ground, the device continuously measures soil resistance and captures reflected seismic waves from subsurface objects or layers. The penetrometer also incorporates precise location, time, and orientation sensors, ensuring accurate geospatial data for each measurement. All collected data is transmitted in real-time to the Local Facility and RAF through, for example, a mesh network communication system, enabling immediate processing and analysis. The network also allows penetrometer-to-penetrometer communication for coordinated measurements of the local soil's seismic velocity and attenuation characteristics to facilitate optimal penetrometer installation, operation, removal, and reuse. This innovative design makes the penetrometer an essential tool for efficient, safe, and accurate subsurface surveying, particularly in hazardous areas.

The mobile unit 18 is designed to transport and deploy penetrometers across the survey area with minimal human intervention. The mobile unit 18 can include an Uncrewed Ground Vehicle (UGV), an Uncrewed Aerial Vehicle (UAV), or an Uncrewed Water Vehicle (UWV), which serves as a versatile and autonomous platform for penetrometer placement operations. This mobile unit 18 is equipped with advanced navigation systems, including RTK GPS and obstacle detection sensors, allowing it to traverse challenging terrains safely and efficiently. The mobile unit 18 features a specialized payload system for storing multiple penetrometers and a mechanism for precise penetrometer deployment. The Mobile Unit also includes data processing and communication equipment.

In one or more embodiments, the Mobile Unit communicates with both the Local Facility and the penetrometers. While the penetrometers analyze sensor data and perform penetrometer-to-penetrometer analysis, the Mobile Unit performs the first layer of Digital Twin processing where the initial spatial mapping effort begins. The Mobile Unit implements the Fog_0 layer of the hierarchical processing structure, performing initial tomographic imaging, suspect soil properties detection, adaptive commanding, and mission coordination.

The external database 22 is a versatile and scalable component of the remote surveying system, designed to augment the capabilities of the RAF. This database can be implemented as a dedicated server or a cloud computing platform, providing additional storage capacity to support the surveying operations. It serves as a centralized repository for a wide range of data relevant to the survey area, including historical and geological information, satellite imagery, previous survey results, and known hazard locations. The external database can also host specialized algorithms or machine learning models that may require more extensive computational resources than available in the field-deployed local facility. By leveraging cloud computing capabilities, the system can perform complex analyses, run simulations, or process large datasets without impacting the real-time operations at the local facility. Additionally, the external database facilitates data sharing and collaboration with other agencies or research institutions, allowing for the integration of diverse data sources to enhance the accuracy and comprehensiveness of the subsurface surveys. This external resource significantly expands the system's analytical capabilities and flexibility, enabling more informed decision-making and improved survey outcomes.

In an embodiment, the remote surveying system 10 operates by first deploying an uncrewed ground vehicle 18 to strategically place high-frequency sensors 16 across a survey area. Initial readings are then taken and analyzed by the penetrometer edge processor(s) to identify areas of interest or potential anomalies. Based on this analysis, additional sensors 16 are precisely positioned to further investigate specific objects or regions, allowing for detailed mapping and characterization of subsurface conditions through iterative surveying and data fusion.

In one or more embodiments, the Local Facility 15 is a key coordination hub of the site examination automation process and allows for high level of automation that makes the remote surveying system safe, effective, and economical. The local facility's operational cycle includes (1) a detailed map of the area to be surveyed; (2) a “first cut” set of penetrometer locations based on the map data; (3) the penetrometer locations are used to calculate a penetrometer installation cycle beginning with the first penetrometer to be installed; (4) the penetrometer installation cycle is used to calculate a path plan for the equipment bringing the penetrometers to their installation locations; (5) the seismic data from all penetrometers, and beginning with the first one, is used to verify that the path to and installation of the next penetrometer in the plan is within site safety rules. The system uses seismic data from installed penetrometers to verify safety for deploying the next one. It checks both the path to the installation site and the site itself against predefined safety rules. This process is repeated for each new penetrometer, ensuring continuous safety assessment throughout the deployment based on real-time seismic data; (6) if a potential safety hazard is identified that would endanger the penetrometer placement equipment, the Mobile Unit or local facility software replans the equipment's route for both safety and for close inspection of the possible safety hazard; (7) the baseline for close inspection is for the local facility to calculate the locations for added penetrometers placed sequentially closer to or around the possible safety hazard; (8) the Local Facility or remote analysis computers use this combination of close inspection, data from high-frequency seismic instrumentation in the instrumented penetrometer, and multiple sensor locations around the suspected safety hazard to calculate a 3-dimensional, or 3-D, image of the suspected safety hazard that is akin to an ultrasound image; (9) close inspection can also be accomplished by using other sensors, such as a ground penetrating radar (GPR) on a specialized uncrewed vehicle, but the detailed analysis of the data remains at the remote analysis facility and the general process of developing a 3-D image remains the same; (10) the remote analysis system then compares the 3-D image of the suspected safety hazard with 3-D solid models of safety hazards of similar size to both characterize and precisely geolocate it; (11) the remote analysis system then classifies the identified potential safety hazard as either non-hazardous or potentially hazardous and requiring intervention by technicians or other personnel; (12) the full analysis of the potential safety hazard is provided to the technicians assigned to remediate or mitigate the hazard; (13) the technicians then report their findings for recording on the system for later processing.

In an embodiment, a detailed map is obtained from outside sources and downloaded through the RAF. In another embodiment, when no sufficient map is available a map can be created, for example, by an UAV equipped with a suitable camera combined with photogrammetry software in the local facility. The map can then be uploaded to the RAF.

In an embodiment, the RAF can be configured to analyze the penetrometer data by combining it with other information such as notes or maps. The RAF may use the results of this data fusion process to develop higher value analysis results such as the most likely artifact type to exist within a given subsurface anomaly by matching those results with computer models, photographs, or detailed descriptions of the ordnance likely to have been used during combat at the site. This information may make the process of eliminating the threat posed by the subsurface artifact safer and less time consuming.

In an embodiment, the remote surveying system includes a human control center that serves as the central hub where operators monitor automated equipment and respond to off-nominal situations. Its staffing level correlates with the number of operational sites and site-specific hazards. This center can be situated anywhere with appropriate office space, utilities, and internet connectivity, offering flexibility in its location.

In an embodiment, the local facility is strategically positioned away from hazardous inspection areas. It functions as a maintenance and support base for the uncrewed vehicles and instrumented penetrometers, housing a well-equipped shop area and maintaining a substantial inventory of parts and supplies.

In an embodiment, the local facility can do “site level” computing: edge in the penetrometer, “Site Level or Fog Layer” in the local facility, the heavy duty computational load of understanding what the threats are in the Remote Analysis Facility. Together, these facilities ensure efficient, safe, and well-supported operations for the remote surveying system across various deployment scenarios. The RAF can control as many sites as needed. It can share new knowledge across sites as soon as it is created. More sites worldwide can include more workstations, and possibly virtual machines, in the RAF.

In one or more embodiments, the RAF performs multi-step AI processing to complete the Digital Twin. In a first step, the RAF correlates site data with accumulated seismic data and associated ground truth from the training database to understand the measurements. In a second step, the RAF merges seismic information with other sensor data, such as magnetometer data, to form a more complete understanding of subsurface conditions. In a third step, the RAF fuses the penetrometer data with all other available data to complete the Digital Twin begun at lower fog layers, creating a comprehensive three-dimensional virtual representation of the survey site. The final Digital Twin supports the technician or sapper assigned to disarm or remediate the identified threat.

In an embodiment, the remote surveying system employs a hierarchical processing structure to efficiently manage data collection, analysis, and decision-making. This structure consists of three primary layers: edge processing, local processing (fog layer), and the Remote Analysis Facility (RAF) or cloud layer.

At the ground level, mobile vehicles (ground, air, and water-based) equipped with various sensors and edge computing capabilities navigate the survey area, detect potential threats, and deploy penetrometers. These vehicles continuously transmit their situational awareness data to the local facility. The penetrometers, featuring internal hammers and potentially other noise-generating mechanisms (akin to loudspeakers), conduct seismic surveys and perform initial data processing. Their edge computing power allows for real-time measurement of local soil characteristics and preliminary threat detection, with this processed data being sent to the local facility.

The local facility, positioned as an intermediary between the field equipment (mobile vehicles and penetrometers) and the RAF, serves as the system's fog layer. This facility houses significant computing resources to perform data fusion from all penetrometers, enabling more comprehensive threat identification. It also manages the deployment strategy for the penetrometer array, determining optimal placement for new units and identifying when existing penetrometers should be retrieved for redeployment. This local processing is used for maintaining the efficiency and effectiveness of the ongoing survey operation.

In one or more embodiments, the RAF can be configured to analyze the penetrometer data by combining it with other information sources. These sources may include combat records and unit histories, which provide context about the types of military activities that occurred in the surveyed area. The system also incorporates detailed descriptions of various types of ordnance and landmines, allowing for more accurate identification of detected objects. Satellite imagery can be used to correlate subsurface findings with surface features or historical changes in the landscape. Operational parameters from past and current surveying missions are also considered to refine the analysis process. The RAF may use the results of this data fusion process to develop higher value analysis results, such as determining the most likely artifact type to exist within a given subsurface anomaly by matching those results with computer models, photographs, or detailed descriptions of the ordnance likely to have been used during combat at the site. This comprehensive approach to data analysis enhances the system's ability to accurately identify and characterize potential threats, making the process of eliminating the threat posed by the subsurface artifact safer and less time consuming.

In one or more embodiments, the RAF is configured for applications other than ordnance detection. For hazardous materials detection, the RAF incorporates records of industrial activity, disposal site histories, and container specifications. For unmarked grave detection, the RAF incorporates historical records and characteristic soil disturbance signatures. For archaeological surveys, the RAF incorporates historical site data, artifact databases, and characteristic subsurface feature signatures. For infrastructure surveys such as bridge foundations or buried utilities, the RAF incorporates construction records, utility maps, and infrastructure specifications. In such embodiments, the penetrometer design may be adapted to site conditions, such as a mole-like configuration for operation in confined or inaccessible areas such as beneath old cities.

In one or more embodiments, each penetrometer is equipped with multiple sensors arranged in different orientations or positions within the housing. This configuration allows a single penetrometer to detect the direction from which seismic waves are received, enhancing its ability to contribute to precise localization of subsurface anomalies.

In one or more embodiments, the system employs a distributed autonomous sensor mesh architecture in which each penetrometer functions as an autonomous computational node capable of peer-to-peer communication and computation without requiring centralized coordination. Each penetrometer broadcasts its composite waveform data, including wave arrival time, amplitude, frequency content, and temporal attenuation, along with its precise location to other penetrometers in the network. Upon receiving broadcasts from neighboring penetrometers, each penetrometer autonomously calculates seismic propagation velocity and spatial attenuation coefficients between itself and its neighbors. This distributed approach enables the array to function as a self-organizing computational mesh where collective behavior emerges from peer interactions rather than central control, providing fault tolerance and scalability to 100 or more penetrometers. The fault-tolerant design ensures that loss of individual penetrometers or fog_0 nodes does not disable the array, as the system continues operating with remaining nodes. This architecture also enables operation in communications-denied environments where centralized infrastructure may be unavailable or compromised.

In one or more embodiments, the system employs temporal oversampling with composite waveform generation to improve signal-to-noise ratios for detecting weak subsurface signals. This approach implements a statistical radar concept using acoustic waves with temporal oversampling analogous to radar processing. The seismic wave generator in a source penetrometer produces multiple hammer impacts at known times, and sensor data from receiving penetrometers is time-aligned via GPS-synchronized timing signals. In some embodiments, the seismic source is external to the penetrometers—for example, a hammer-driven plate coupled to the ground surface—rather than a generator integral to a penetrometer, the system using the external source provided its timing and location are known. Composite waveforms are generated locally at each penetrometer through statistical aggregation of sensor data across the multiple impact events, dramatically improving the signal-to-noise ratio and enabling detection of weak reflected signals that would otherwise be indistinguishable from background noise. Test data supports aggregation of 64 or more hammer impacts for high quality composite waveform generation, with arrival time precision improving by a factor of 8× with 64 or more hammer impacts. Each penetrometer outputs composite waveform data along with extracted parameters such as wave arrival time, amplitude, frequency content, and temporal attenuation, rather than transmitting raw sensor data. By transmitting composite waveform data and extracted parameters rather than raw sensor data, the system avoids bandwidth bottlenecks when scaling to large numbers of penetrometers. In some embodiments, raw sensor data is additionally transmitted, for example for diagnostic purposes.

In one or more embodiments, the system employs adaptive power management via distributed commanding to extend operational duration. Each receiving penetrometer calculates signal-to-noise ratio as composite waveforms are generated and autonomously commands the source penetrometer to continue hammer action if the signal-to-noise ratio is improving above a threshold. This hierarchical decision-making approach combines local rules-based decisions for fast response with strategic decisions for resource allocation, concentrating power expenditure only where detection remains ambiguous and extending battery life during multi-day operations. Adaptive commanding may extend operational duration by a factor of 3 to 5 compared to fixed stimulus protocols.

In one or more embodiments, the system detects subsurface anomalies through seismic property discontinuity detection. As the penetrometer array grows incrementally, the system builds a spatial map of seismic propagation velocity and attenuation values across the survey area. The system identifies discontinuities where seismic propagation velocity or attenuation between one penetrometer pair differs significantly from neighboring pairs by more than a threshold based on statistical standard deviation that is continuously updated for the site. These discontinuities are flagged as locations of interest requiring closer inspection, as they may indicate the presence of voids, dense objects, disturbed soil, or layer boundaries. This approach complements tomographic imaging by providing faster detection with fewer penetrometers and guiding strategic array expansion.

In one or more embodiments, successive impacts that drive a penetrometer to progressively greater depth are treated as a sequence of seismic sources at known, increasing source depths, the source depth of each impact being determined from a penetration measurement (for example, a blow count with a penetration-per-blow estimate, or a measured displacement) and the source horizontal position being determined from the RTK GPS position. Because a receiving penetrometer's orientation is referenced to local gravity, the source-to-receiver geometry, including the angle of incidence at the receiver, is known in an absolute frame. Sensor data recorded across the sequence of source depths forms a depth-stepped, common-receiver gather, and changes in the recorded arrivals across the sequence—after accounting for the predictable depth-dependent changes in source coupling and geometric spreading—are used to detect and help locate a subsurface anomaly that perturbs the propagation paths.

In one or more embodiments, the system detects multiple wave types to enable detection of objects spanning a wide range of sizes. The system detects high-frequency waves, such as primary compressional waves at approximately 1 kHz, which provide resolution suitable for detecting landmine-sized objects with dimensions on the order of 10 to 20 centimeters. The system also detects lower-frequency waves, such as secondary shear waves at approximately 100 to 200 Hz, which enable detection of larger unexploded ordnance with dimensions greater than 50 centimeters. This dual-wave detection capability allows a single sensor array to replace multiple specialized detection technologies, enabling threat detection spanning multiple orders of magnitude in object size.

In one or more embodiments, the system supports multi-modal deployment flexibility through a platform-agnostic penetrometer design. The penetrometer may include a ground contact blade or gyroscope configured to self-right the penetrometer when dropped from a height of at least one meter, and a housing configured to withstand impact forces from such a drop. The control unit may be configured to autonomously initialize upon detecting ground contact. This design enables deployment by multiple methods including unmanned aerial vehicle delivery for difficult terrain such as steep slopes, crater-pocked areas, forested regions, or areas with unstable ground, as well as robotic placement via ground vehicles and manual installation by personnel.

In one or more embodiments, the system performs real-time hyperlocal seismic property measurement with continuous recalculation as new penetrometers are added to the array. Seismic velocity and attenuation coefficients are recalculated in near real-time as the array expands, and penetrometer spacing is dynamically adapted based on updated measurements. Properties are mapped at resolutions ranging from 0.5 to 10 meters rather than assumed uniform across the survey area. Temporal oversampling with 64 or more hammer impacts combined with cross-correlation analysis provides single-path velocity precision of approximately 0.5%, dominated by RTK GPS position uncertainty at typical penetrometer spacings. In operational deployment, multiple source penetrometers create overlapping ray path coverage through the subsurface, with typical arrays placing multiple ray paths through each cubic meter of subsurface volume. This tomographic overdetermination enables the system to constrain velocity estimates with precision of 0.1-0.3% in individual voxels. When combined with spatial gradient analysis across multiple voxels, the system can reliably detect velocity anomalies of 1-2%, which is significantly smaller than natural soil heterogeneity variations (typically 5-10%).

In one or more embodiments, the system employs a hierarchical fog architecture with specific functional allocation across processing layers. At the Edge layer, each penetrometer performs composite waveform generation, frequency content analyses, and temporal attenuation calculation, with any pair of penetrometers capable of seismic propagation velocity calculation and spatial attenuation coefficient calculation. At the Fog_0 layer, which may be implemented on Mobile Units, the system performs suspect soil properties detection, initial tomographic imaging, adaptive commanding, and mission coordination. At the Fog_1 layer, implemented at the site facility, the system performs full 3D reconstruction, AI threat identification, and digital twin creation and revision. At the Cloud layer, the system performs full site tomography for enhanced digital twin generation, maintains a database of tomographic images versus ground truth for improved identification, and enables worldwide threat data sharing across multiple survey sites.

### High-Frequency Surveying

In one or more embodiments, the system utilizes penetrometers capable of detecting frequencies much higher than traditional seismic equipment, with sensors sampled at rates from approximately 1 Hz up to approximately 60,000 Hz, which allows for the detection and characterization of smaller objects and finer subsurface features. Unlike traditional geophones that may operate at frequencies 1 to 5 Hz, this system incorporates sensors capable of sampling at rates as high as 60,000 Hz while detecting seismic wave frequency content extending up to approximately 2,000 Hz. This dramatic increase in frequency range allows for the detection and characterization of much smaller subsurface objects-down to 3 millimeters in size, compared to the meter scale of conventional systems. The higher frequencies provide significantly improved resolution, analogous to the difference between low and high-resolution imaging in other fields. This enhanced capability is achieved through a combination of highly sensitive sensors, continuous calculation of the local soil characteristics, advanced signal processing techniques, precise placement for each individual penetrometer based on soil characteristics and selected threat size limits, and the strategic sensor placement within the penetrometer. The system's ability to both generate and detect high-frequency seismic waves enables the RAF to create detailed, three-dimensional subsurface images, analogous to medical ultrasound technology. This high-frequency approach, coupled with the penetrometer's unique design for in-situ soil measurements, allows for unprecedented accuracy in identifying and characterizing small subsurface anomalies or artifacts, making it particularly valuable for applications such as unexploded ordnance detection or precise geological surveys in challenging environments. The artifacts can include items such as hand grenades, unmarked graves, foundations, archaeology, buried utilities, hazmat drums, 250 lb bombs and sewer pipelines.

### Penetrometers

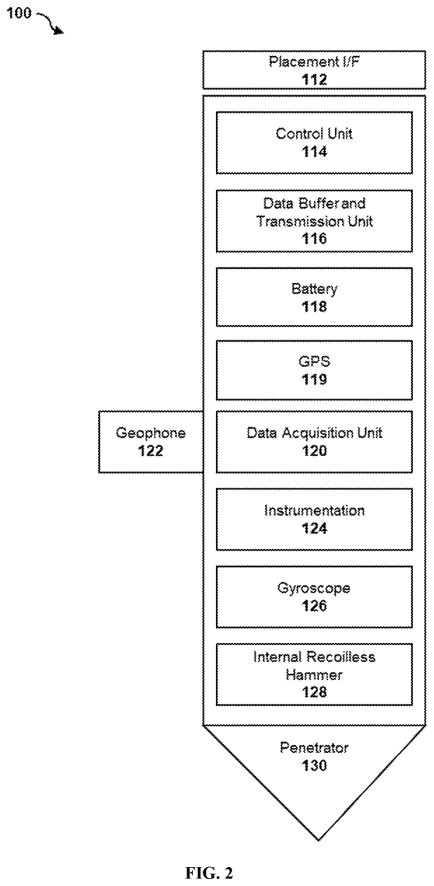

FIG. 2 shows a penetrometer 100, according to an embodiment of the present disclosure. The penetrometer 100 includes a placement interface 112, control unit 114, data buffer and transmission unit 116, battery 118, GPS receiver 119, data acquisition unit 120, geophone 122, instrumentation 124, gyroscope 126, internal recoilless hammer 128, and penetrator 130. The placement interface 112 allows for easy handling and deployment by uncrewed vehicles or other placement systems. The control unit 114 provides edge computing and coordinates operations and communications within the penetrometer. This unit manages system initialization, sensor operations, data preprocessing, power management, and communication protocols. It interfaces with the data acquisition unit 120, which collects readings from the geophone 122, instrumentation 124, and gyroscope 126. These sensors provide crucial data on seismic waves, orientation, and subsurface soil characteristics. The penetrometer will also get data from a Global Navigational Satellite System (GNSS) [GPS is a part of that] with Real Time Kinematic (RTK) correction. This is where the precise location and time signals come from.

The internal recoilless hammer 128 serves a dual purpose: it drives the penetrometer into the ground during installation and generates seismic waves for surveying. The penetrator 130 is the physical interface with the soil, designed for optimal penetration and seismic wave transmission. The gyroscope 126 ensures the penetrometer maintains proper orientation during installation. All collected data is temporarily stored in the data buffer and transmission unit 116 before being sent to the local facility for processing and upload to the RAF.

The battery 118 powers all onboard systems, with its usage optimized by the control unit 114. The placement interface 112 is designed for compatibility with mobile unit or other deployment systems, facilitating easy handling and precise positioning. All these components work in concert, communicating through internal protocols managed by the control unit 114. The penetrometer operates as part of a larger network, sending data to and receiving commands from the local facility, which coordinates the overall survey operation. This integrated approach allows for adaptive, real-time surveying strategies based on the data collected and analyzed across multiple penetrometers in the field.

In one or more embodiments, the seismic energy is generated using recoilless hammers and/or noisemakers (such as a loudspeakers) that are oriented horizontally and can be commanded to operate at specific frequencies.

In one or more embodiments, the penetrometer combines seismic source and sensor capabilities in a single unit, featuring multiple high-frequency sensors capable of being sampled at rates up to 60,000 Hz to detect seismic wave frequency content from approximately 10 Hz to approximately 2,000 Hz, far exceeding conventional 1 to 5 Hz geophones. Its dynamic design allows for self-installation using an internal recoilless hammer positioned at the penetrator tip 130 or at the placement interface 112, with gyroscopic stabilization ensuring vertical alignment. This configuration enables precise seismic impacts while minimizing shock to other components. The device can also be installed conventionally using an external hammer if needed.

The penetrometer's versatility extends beyond installation, as it can generate seismic waves post-installation and incorporates high-precision location and time instrumentation. Its modular design adapts to various site conditions and accommodates different placement systems. On-board electronics handle data acquisition and conversion, while mesh network capabilities enable remote command reception and data transmission. A magnetic interface facilitates efficient handling by uncrewed vehicles, enhancing overall system productivity and flexibility in deployment scenarios.

The data acquisition unit 120 interfaces directly with the sensors, including the geophone 122, which detects seismic waves, and internal instrumentation 124 such as Global Navigation Satellite System (GNSS) for precise geographic location and time, angle sensors, accelerometers and microphones for high-frequency detection.

A gyroscope 126 maintains the penetrometer's vertical orientation during installation and operation. The internal recoilless hammer 128 serves a dual purpose: it drives the penetrometer into the ground and generates seismic waves for subsurface analysis. Finally, the penetrator 130 at the base of the device is designed to efficiently enter the soil while housing sensors for direct contact with the subsurface environment.

In an embodiment, the integrated system allows the penetrometer to simultaneously install itself, generate seismic waves, collect high-resolution data about the subsurface, and transmit this information for immediate analysis, making it a powerful tool for comprehensive and efficient subsurface surveys.

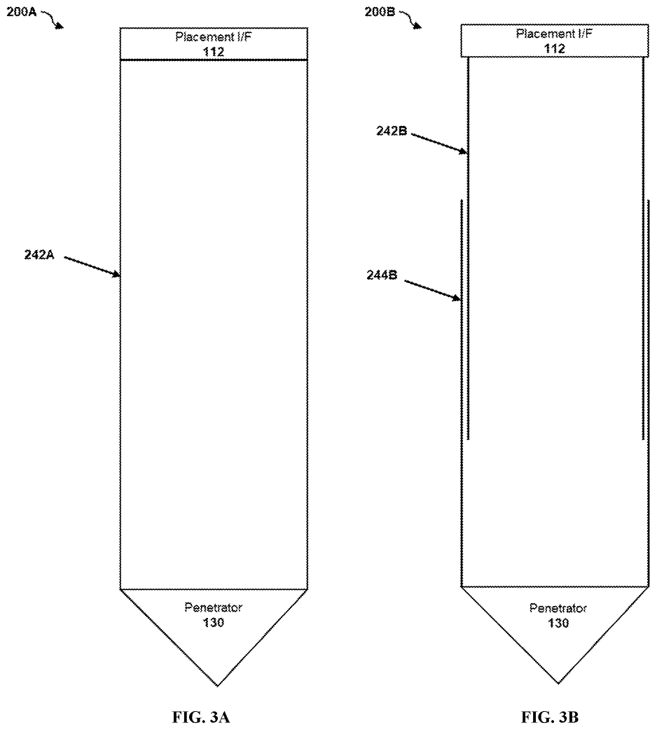

FIGS. 3A and 3B show penetrometers 200A, 200B, according to embodiments of the present disclosure. The penetrometer 200A can include a body 242A that is solid. The penetrometer 200B can also be an extendable body with walls 242B and 244B. In FIG. 3A, the penetrometer 200A features a solid body 242A, offering enhanced structural integrity, improved resistance to impact forces during installation, and better protection for internal components against harsh environmental conditions. This solid design may provide superior heat dissipation and simplified manufacturing but could limit adaptability to uncrewed vehicle penetrometer handling systems' kinematic limitations. In FIG. 3B, the penetrometer 200B utilizes an extendable body with walls 242B and 244B, employing a telescoping mechanism. This design allows for adjustable length, accommodating various uncrewed vehicle kinematic needs and soil depths and conditions, while also enabling compact storage and transportation when retracted. The extendable configuration offers greater flexibility in deployment scenarios, especially in confined spaces, and potentially allows for reaching greater depths than a fixed-length design.

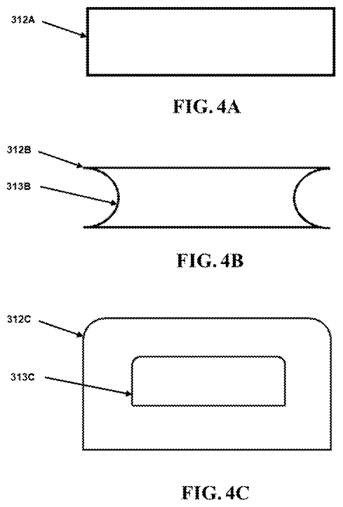

FIGS. 4A, 4B, and 4C shows various placement interface designs (312A, 312B, 312C) for penetrometers according to embodiments of the present disclosure. These interfaces are engineered to facilitate efficient and secure handling by robotic arms or other mechanical placement devices. In FIG. 4A, the placement interface 312A features a solid, flat surface compatible with suction devices or magnetic plates, offering a simple yet effective connection method. FIG. 4B showcases placement interface 312B with curved sections 313B, specifically designed to accommodate gripping components for secure attachment to placement mechanisms. FIG. 4C presents a more intricate design in placement interface 312C, incorporating a central void 313C that allows for easy handling by human beings. Each of these designs is tailored to optimize the interaction between the penetrometer and its deployment system, ensuring precise positioning and efficient installation across various operational scenarios and environments.

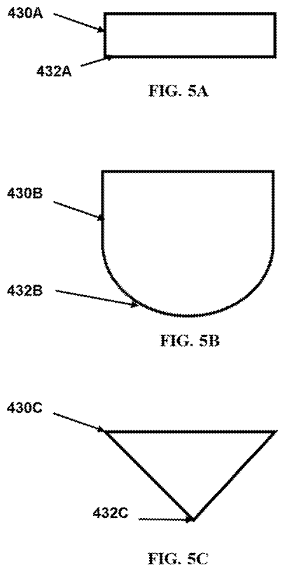

FIGS. 5A, 5B, and 5C illustrate three distinct penetrator interface designs (430A, 430B, 430C) for the penetrometer system, each tailored to specific soil conditions and penetration requirements. The flat structure 430A features a flat end 432A, suitable for softer soils where increased resistance to installation is desired for added seismic energy generation. The round tip structure 430B with its curved end 432B offers customized penetration resistance for a variety of soil types. The conical tip structure 430C, ending in a pointed tip 432C, is designed for maximum penetration capability, particularly effective in harder or more compact soil conditions. These varied designs enable the penetrometer system to adapt to diverse geological environments, optimizing its effectiveness across different deployment scenarios.

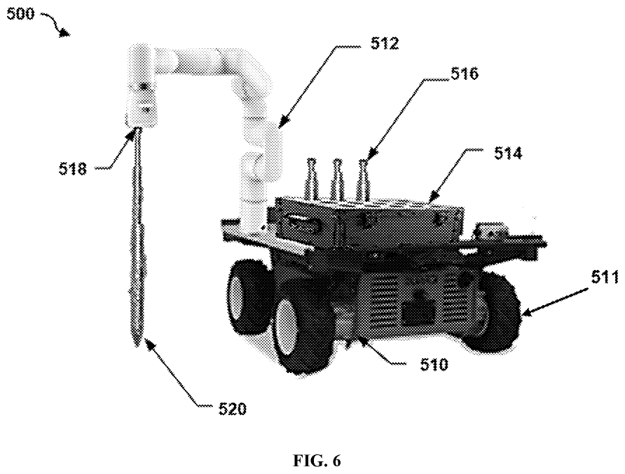

FIG. 6 shows a mobile unit 500 according to an embodiment of the present disclosure. The mobile unit 500 is an uncrewed ground vehicle with a motor 510, tires 511, an arm 512, a quiver 514, a first penetrometer 516, an engage unit 518, and a second penetrometer 520. The motor 510 is used to power tires 511 for traveling through ground terrain. The quiver 514 is a container designed to hold multiple penetrometers while the mobile unit 500 travels to place the penetrometer. The quiver 514 is also designed to allow the penetrometer to be accessed and removed for placing the penetrometer on the ground but also for accepting the penetrometer when picked up by the mobile unit 500. The first penetrometer 516 is located in the quiver 514 and can be removed for surveying. The engage unit 518 is designed to connect the penetrometer to the arm for placing and releasing the penetrometer whether on the ground or back in the quiver 514. The engage unit 518 can be a gripping mechanism, magnetic mechanism, air pressure mechanism, or other mechanism for connecting to and moving the penetrometer. The second penetrometer 520 is connected to the engage unit 518 and can be placed in the ground or into the quiver 514.

In one or more embodiments, the mobile unit 500 includes a diverse range of uncrewed vehicles (ground, water, and air) for installing instrumented penetrometers, maximizing efficiency through full automation. The mobile unit 500 can significantly reduce inspection costs, eliminate human exposure to hazardous objects, and enable exploration of remote sites, including lunar locations. Ground vehicles (wheeled, tracked, or legged) are selected based on site conditions, with wheeled options preferred for productivity and cost-effectiveness. Water vehicles, designed for shallow operations, serve in swampy or marshy areas. Air vehicles, typically handling one penetrometer at a time via electromagnet, offer precise placement capabilities and access to locations that may be inaccessible to ground vehicles and locations with only a small area to be searched. Human involvement is limited to logistical tasks such as unpacking, initialization, loading, maintenance, and repacking of penetrometers, ensuring a balance between automation and necessary manual oversight.

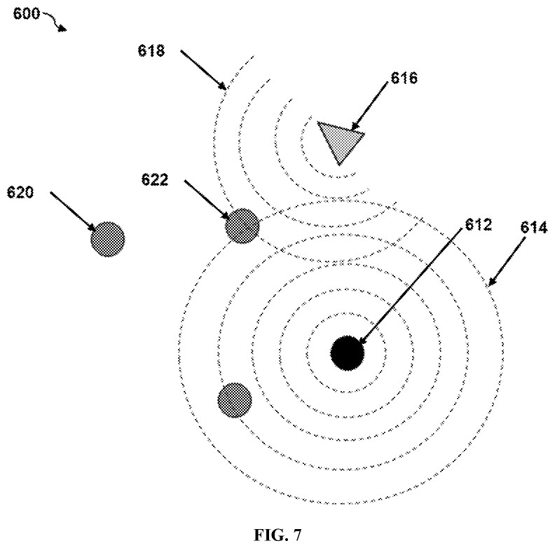

FIG. 7 shows a hammer-generated seismic energy map 600, according to an embodiment of the present disclosure. The map includes a penetrometer 612, seismic waves 614, subsurface anomaly 616, reflected seismic waves 618, previously emplaced penetrometer 620, and primary penetrometer 622. The penetrometer 612 generates seismic waves 614 that propagate through the surrounding medium. These waves interact with a subsurface anomaly 616, producing reflected and refracted seismic waves 618 that are detected by both the originating penetrometer 612 and a previously emplaced penetrometer 620. The primary penetrometer 622 is able to read the reflected seismic energy and can serve as a reference point. This visualization demonstrates the system's ability to use multiple penetrometers in concert to detect and characterize subsurface features, leveraging direct, refracted, and reflected seismic waves for comprehensive underground mapping.

The seismic power does not travel horizontally, however. Rather it propagates through the soil in all directions including down. This results in something more akin to a hemisphere with the penetrometer at the center rather than a circle with the penetrator at the center.

The result of this is that this approach searches overlapping volumes of soil, not overlapping areas of soil. Any anomaly will be viewed as part of a 3-D underground world rather than as part of a 2-D surface map.

Note that in actual operation, seismic sensors will be placed such that their hemispherical coverage volume overlap, thus significantly increasing the likelihood that one or more observations will be made of the longest dimension of an underground artifact or anomalous volume of soil.

The result of all this is that the Digital Twin discussed above is enabled as a 3-D virtual world rather than a 2-D threat map.

The local facility will use the local soil's seismic propagation velocity and attenuation characteristics to balance penetrometer spacing between finding small objects with closely spaced penetrometers or higher productivity that only finds larger objects with wider penetrometer spacing. By installing the penetrometers a significant distance apart (e.g., 25 meters), and using the hammer-induced and reflected seismic energy to locate subsurface anomalies, embodiments of the present disclosure can cover large areas quickly. For example, if a single UGV can install one penetrometer every 10 minutes, it can install approximately 49 penetrometers in an 8-hour shift. If the penetrometers are placed in a 7 by 7 matrix and spaced 25 meters apart, the included area would be 150 by 150-meters or 22,500 square meters. If the sensible area extends 12.5-meters beyond the edge of the included area, then the sensed area becomes 175 by 175-meters or 30,625 square meters. At that rate of inspection, a single system consisting of one local facility and five UGVs could inspect a site measuring one square kilometer in less than seven working shifts, or less than three days with operators relieved every 8 hours.

The system concept's scalability, the fact that a single local facility combined with a highly capable control station can control many relatively inexpensive UGVs, allows the system to expand as needed to address very large areas that may harbor hazardous objects. The merging of advanced robot management tools, e.g., algorithms for swarm path planning and replanning, to enhance the capabilities of the autonomous UGV robots decreases the operator-to-robot ratio and minimizes human operator labor. The system's use of retrievable and reusable penetrometers, i.e., those that are too far from the seismic stimulus to sense even the highest power seismic energy or that no longer have sufficient battery power to function, reduces recurring costs.

The process begins with the penetrometers being inserted into the ground by uncrewed ground vehicles. These penetrometers serve a dual purpose: they act as both seismic sources and sensors. When a penetrometer is hammered into the ground, it generates high-frequency seismic waves that propagate through the surrounding soil. The seismic source elements in each penetrometer also produce seismic stimulus in focused directions and at specific frequencies. These waves interact with subsurface objects and structures, reflecting and refracting based on the properties of the materials they encounter.

The reflected/refracted high-frequency waves are then detected by the network of penetrometers deployed across the survey area. Each penetrometer is equipped with multiple types of sensors, including geophones, microphones, and accelerometers, all capable of detecting these high-frequency signals. The use of multiple sensor types and their strategic placement in various directions and at various depths allows for the capture of a rich dataset that includes information from different angles and perspectives.

The high-frequency nature of these waves provides several advantages. Firstly, it allows for better resolution of small objects and fine details in the subsurface, as the shorter wavelengths can interact with smaller features. Secondly, it enables more precise determination of object boundaries and characteristics. However, high-frequency waves also attenuate more rapidly in soil, which is why the system uses a dense network of sensors to ensure adequate coverage and signal strength.

The data collected from this network of high-frequency sensors is then transmitted to powerful computer systems for processing and analysis. Processing at the local facility identifies small potential threats using data fusion techniques to merge the data from multiple penetrometers. Advanced algorithms in the RAF fuse the data from multiple sensors and sensor types and use artificial intelligence and machine learning to create detailed 3D images of the subsurface. These images can reveal the presence, size, shape, and depth of buried objects with a level of detail not achievable with lower-frequency systems.

By leveraging the properties of high-frequency seismic waves and combining them with advanced sensing and data processing techniques, this system pushes the boundaries of what's possible in remote subsurface surveying, offering unprecedented insight into underground conditions across large areas.

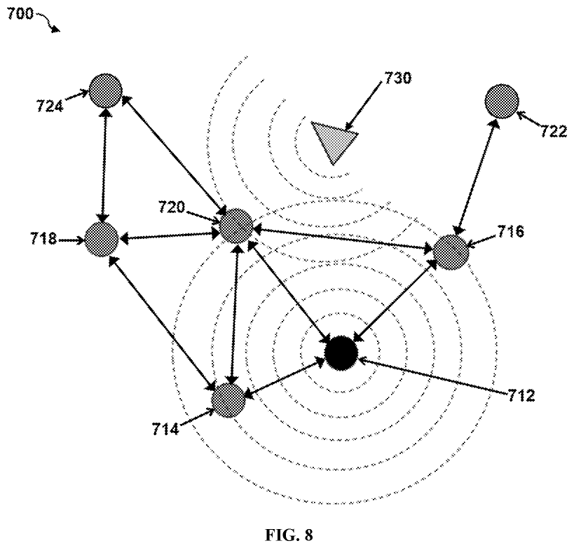

FIG. 8 shows a distributed mesh architecture 700 according to an embodiment of the present disclosure. The system includes a plurality of penetrometers 712, 714, 716, 718, 720, 722, 724, each functioning as an autonomous computational node capable of peer-to-peer communication without requiring centralized coordination. Bidirectional communication links connect the penetrometers in a mesh configuration, with penetrometer 724 communicating with penetrometers 718 and 720; penetrometer 718 communicating with penetrometers 720 and 714; penetrometer 720 communicating with penetrometers 714, 712, and 716; and penetrometer 716 communicating with penetrometer 722. Each penetrometer broadcasts composite waveform data, including wave arrival time, amplitude, frequency content, and temporal attenuation, along with its precise location to neighboring penetrometers. Upon receiving broadcasts from neighboring penetrometers, each penetrometer autonomously calculates seismic propagation velocity and spatial attenuation coefficients between itself and its neighbors. This distributed approach enables the array to function as a self-organizing computational mesh where collective behavior emerges from peer interactions rather than central control. The penetrometer network collectively detects a subsurface anomaly 730 through the distributed seismic property calculations and discontinuity detection.

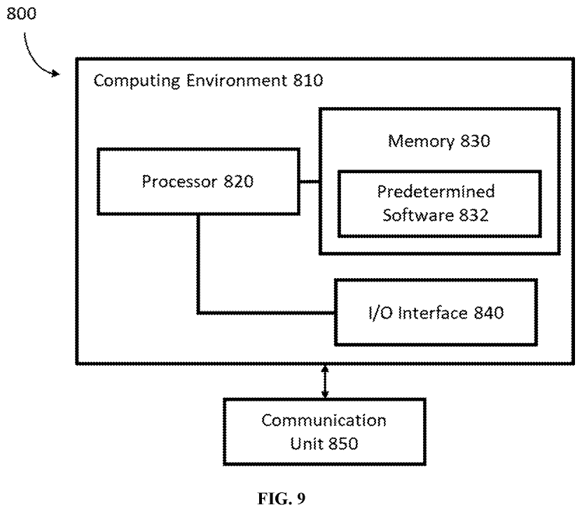

FIG. 9 shows a computing system 800 that is part of the penetrometer, local facility, RAF, and mobile unit for remote surveying. According to example embodiments shown schematically in FIG. 8, the computing system 800 includes a computing environment 810 and a communication unit 850. The computing environment 810 includes a processor 820, a memory 830, and an I/O interface 840. The computing environment 810 is coupled to the communication unit 850 through the I/O interface 840.

The processor 820 can typically control the overall operations of the computing environment 810, such as the operations associated with data acquisition, data processing, and data communications. The processor 820 can include one or more processors to execute instructions to perform all or some of the steps in the above-described methods. Moreover, the processor 820 can include one or more modules that facilitate the interaction between the processor 820 and other components. The processor may be or include a central processing unit (CPU), a microprocessor, a single chip machine, a graphical processing unit (GPU), System on a Chip (SoC), Tensor Processing Unit (TPU), Quantum Processor, Vision Processing Unit (VPU) or the like.

The memory 830 can store various types of data to support the operation of the computing environment 810. The Memory 830 can include predetermined software 831. Examples of such data comprise instructions for any applications or methods operated on the computing environment 810, financial data, user data, entity data, etc. The memory 830 may be implemented by using any type of volatile or non-volatile memory devices, or a combination thereof, such as a static random-access memory (SRAM), Dynamic Random-Access Memory (DRAM), an electrically erasable programmable read-only memory (EEPROM), an erasable programmable read-only memory (EPROM), a programmable read-only (PROM), an erasable programmable read-only memory (EPROM), a programmable read-only memory (PROM), a read-only memory (ROM), a magnetic memory, a flash memory, a magnetic or optical disk.

The I/O interface 840 can provide an interface between the processor 820 and peripheral interface modules, such as RF circuitry, external port, proximity sensor, audio and speaker circuitry, video and camera circuitry, microphone, accelerometer, display controller, optical sensor controller, intensity sensor controller, other input controllers, keyboard, a click wheel, buttons, Touchscreen Controller, Pressure Sensor, Light Emitting Diode (LED) Controller, Universal Serial Bus (USB) Controller, Serial Peripheral Interface (SPI) Bus Controller, Digital-to-Analog Converter (DAC), Analog-to-Digital Converter (ADC), Radio Frequency Identification (RFID) Reader/Writer and the like. The buttons may include but are not limited to, a home button, a power button, and volume buttons.

Communication unit 850 provides communication between the processing unit, an external device, mobile device, and a webserver (or cloud). The communication can be done through, for example, a mesh network, WIFI, or BLUETOOTH hardware protocols, Cellular Networks (4G LTE, 5G), NFC (Near Field Communication), Radio Frequency Identification (RFID), Satellite Communication, Ethernet or the like. The communication unit 850 can be within the computing environment or connected to it.

In one or more embodiments, the computing environment 810 can be coupled to a user interface that can include a speaker, lights, display, haptic feedback motor, Gesture Recognition System, Tactile Feedback Devices, Biometric Sensors, Voice Recognition System or other similar technologies for communicating with the user.

In some embodiments, there is also provided a non-transitory computer-readable storage medium comprising a plurality of programs, such as comprised in the memory 830, executable by the processor 820 in the computing environment 810, for performing the above-described methods. For example, the non-transitory computer-readable storage medium may be a ROM, a RAM, or the like.

The non-transitory computer-readable storage medium has stored therein a plurality of programs for execution by a computing device having one or more processors, where the plurality of programs for execution by a computing device having one or more processors, where the plurality of programs when executed by one or more processors, cause the computing device to perform the above-described method for high-frequency remote surveying.

In some embodiments, the computing environment 810 may be implemented with one or more application-specific integrated circuits (ASICs), digital signal processors (DSPs) digital signal processing devices (DSPDs), programmable logic devices (PLDs), field-programmable gate arrays (FPGAs), graphical processing units (GPUs), controllers, micro-controllers, microprocessors, or other electronic components, for performing the above methods.

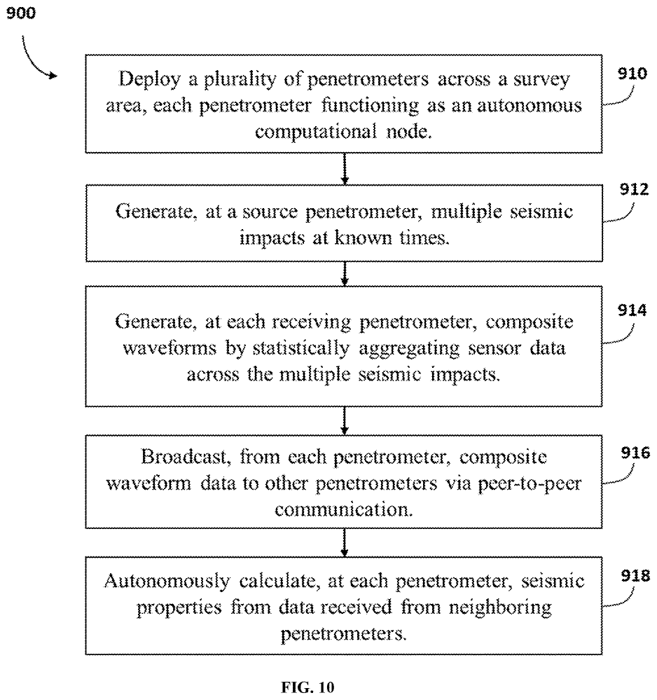

FIG. 10 shows an example method for high-frequency remote surveying in accordance with the present disclosure. The method can be applied to a system for high-frequency remote surveying that includes a plurality of penetrometers functioning as autonomous computational nodes capable of peer-to-peer communication.

In step 910, the remote surveying system deploys a plurality of penetrometers across a survey area, each penetrometer functioning as an autonomous computational node. The penetrometers may be deployed via mobile units such as uncrewed ground vehicles, uncrewed aerial vehicles, or manual installation depending on terrain conditions. Each penetrometer includes a seismic wave generator, sensors capable of detecting high-frequency seismic waves, and a control unit configured for peer-to-peer communication with other penetrometers in the network. In one or more embodiments, the penetrometers are deployed at precisely measured positions using RTK GPS.

In step 912, the remote surveying system generates, at a source penetrometer, multiple seismic impacts at known times. The seismic wave generator, which may include an internal recoilless hammer, produces multiple hammer impacts at precisely known times using GPS-synchronized timing signals. This temporal oversampling approach enables statistical aggregation of sensor data to improve signal-to-noise ratios. In one or more embodiments, the seismic impacts are generated by an external source rather than a source penetrometer.

In step 914, the remote surveying system generates, at each receiving penetrometer, composite waveforms by statistically aggregating sensor data across the multiple seismic impacts. Sensor data from receiving penetrometers is time-aligned via the GPS-synchronized timing signals, and composite waveforms are generated locally at each penetrometer through statistical aggregation of sensor data across the multiple impact events. This dramatically improves the signal-to-noise ratio and enables detection of weak signals that would otherwise be indistinguishable from background noise.

In step 916, the remote surveying system broadcasts, from each penetrometer, composite waveform data to other penetrometers via peer-to-peer communication. Each penetrometer broadcasts its composite waveform data, including wave arrival time, amplitude, frequency content, and temporal attenuation, along with its precise location to other penetrometers in the network. This peer-to-peer communication enables the array to function as a self-organizing computational mesh without requiring centralized coordination.

In step 918, the remote surveying system autonomously calculates, at each penetrometer, seismic properties from data received from neighboring penetrometers. Upon receiving broadcasts from neighboring penetrometers, each penetrometer autonomously calculates seismic propagation velocity and spatial attenuation coefficients between itself and its neighbors. This distributed computation approach provides fault tolerance and scalability, as the system continues operating despite loss of individual penetrometers.

In step 920, the remote surveying system builds a spatial map of seismic velocity and attenuation values across the survey area and identifies discontinuities as locations of interest. As the penetrometer array grows incrementally, the system identifies discontinuities where seismic propagation velocity or attenuation between one penetrometer pair differs significantly from neighboring pairs. These discontinuities are flagged as locations of interest requiring closer inspection, as they may indicate the presence of voids, dense objects, disturbed soil, or layer boundaries.

In step 922, the remote surveying system generates a survey report based on the distributed seismic data. This report synthesizes the seismic property data from the distributed penetrometer network into actionable intelligence, including detailed subsurface maps, identified anomalies, and characterizations of geological features. Advanced algorithms, possibly incorporating artificial intelligence and machine learning techniques, analyze the seismic wave patterns, reflections, and refractions to construct a three-dimensional model of the subsurface. The report may include visualizations such as cross-sectional views, depth maps, and anomaly highlights, along with quantitative data on local seismic propagation velocity and attenuation characteristics, and potential hazards like unexploded ordnance or voids.

In an embodiment, when the distributed penetrometer network detects an object of interest through seismic property discontinuities, the system can determine that additional, more detailed investigation is required. The system analyzes the seismic data and calculates optimal locations for deploying additional penetrometers closer to or around the detected anomaly. Additional penetrometers may be deployed to the calculated locations to conduct higher-resolution measurements. The resulting data is integrated with existing information through the peer-to-peer network to create a more comprehensive and detailed survey. This adaptive approach allows for dynamic, targeted investigation of subsurface anomalies, enhancing the system's ability to characterize and precisely locate objects such as unexploded ordnance or other significant geological features.

In one or more embodiments, the distributed penetrometer network employs sensor fusion techniques to merge data from multiple penetrometers, thereby improving threat detection thresholds and generating a comprehensive survey of the area. This process leverages the peer-to-peer communication capabilities of the penetrometer network to create a more accurate and detailed picture of subsurface anomalies without requiring centralized processing.

For instance, when one penetrometer generates seismic waves, the sensors on multiple penetrometers detect reflections and autonomously calculate seismic properties. Each penetrometer analyzes the received waveforms, considering factors such as wave arrival time, amplitude, frequency content, and temporal attenuation. This multi-point data collection through the distributed network allows for advanced analysis techniques such as triangulation, distance estimation, and size estimation. For triangulation, by comparing arrival time data from multiple penetrometers, the system can estimate the general location of an anomaly. For distance estimation, using the locally calculated seismic velocity and precise signal reception times at each penetrometer, the system calculates distance estimates from each sensor to the anomaly. For size estimation, the reflected spectra at each penetrometer provide data for estimating the anomaly's size.

The distributed penetrometer network combines these analyses to generate a preliminary characterization of the detected anomaly. While individual penetrometers autonomously calculate seismic properties and broadcast composite waveform data, the collective network performs the more complex task of data fusion through peer-to-peer communication. This includes combining data to estimate size and location, and potentially commanding additional penetrometers to be deployed closer to a potential threat based on predefined rule systems.

As the precision of the distributed seismic measurements increases relative to the size of the artifact, more details emerge, allowing for increasingly sophisticated analysis. This approach can provide sufficient detail to differentiate between different types of subsurface objects, such as distinguishing a 155 mm cannon shell from an 81/82 mm mortar shell, especially after closer inspection enabled by adaptive deployment of additional penetrometers to the area of interest.

In one or more embodiments, the receiving penetrometer recovers a wave type that is below the noise floor of any individual impact event through a technique referred to herein as anchor-stacking. The receiving penetrometer first identifies a detectable wave type in each impact record, such as a higher-amplitude shear wave or guided wave, by finding the sample at which the sensor signal first deviates from a pre-impact baseline noise level by more than a threshold. The receiving penetrometer then defines a pre-arrival time window of bounded duration ahead of the detected first deviation. The bounded duration is selected based on a maximum plausible propagation velocity difference between the two wave types and the source-receiver distance. In a representative embodiment in a cohesive soil with a compressional-wave velocity of approximately 270 to 290 meters per second and a shear-wave or guided-wave velocity of approximately 130 to 160 meters per second, a pre-arrival window of approximately 20 to 25 milliseconds at a source-receiver distance of 4 meters provides margin to capture the compressional-wave arrival together with a quiet baseline interval for noise characterization.

The receiving penetrometer then stacks sensor data within the pre-arrival time window across multiple impact events, aligned to the first deviation of the detectable wave type. Because the timing of the detectable wave type is consistent between impacts, this stacking causes any coherent wave content within the pre-arrival window to build constructively while incoherent noise averages down. A wave type that was below the noise floor on any single impact record is thereby recovered as a coherent feature within the composite waveform.

In one or more embodiments, the three orthogonal axes of a three-axis accelerometer mounted in a penetrometer are analyzed independently rather than as a root-sum-of-squares composite. A composite formed by squaring the individual axes and taking the square root rectifies the waveform and frequency-doubles certain spectral features; analyzing each axis independently preserves features that the composite obscures. The three axes are then transformed into a source-aligned coordinate system comprising a radial axis along a vector from the penetrometer to a seismic source, a transverse axis perpendicular to both the radial axis and a vertical axis, and the vertical axis aligned with local gravity.

The rotation from the three orthogonal accelerometer axes to the source-aligned coordinate system is initially estimated from a static gravity reading of the accelerometer and a Global Navigation Satellite System-derived geometry between the penetrometer and the seismic source. The rotation is then iteratively refined by adjusting one or more angles of the rotation to minimize compressional-wave energy on the transverse axis.

In one or more embodiments, a vertical impact source-whether a downward-driven penetrometer tip or an external surface plate-excites compressional (P) and vertically polarized shear (SV) body waves together with Rayleigh surface waves. For a source at or near the surface the Rayleigh component is comparatively strong; for a source at depth, such as a penetrometer tip, the radiated energy shifts toward downgoing body waves and the Rayleigh excitation decreases with increasing source depth. The body waves probe a subsurface volume, while the Rayleigh waves probe the near-surface and provide surface-wave dispersion from which a shear-wave velocity profile is derived.

In one or more embodiments, for a vertical source over a laterally homogeneous medium the wavefield is substantially confined to a sagittal plane containing the source and the receiver, such that the transverse horizontal component of the recorded motion contains substantially no energy. Energy appearing in the transverse component therefore indicates lateral heterogeneity, such as a subsurface anomaly, and the system uses transverse-component energy as an indicator of, and to assist in locating, such heterogeneity.

Because compressional-wave particle motion is longitudinal, any compressional-wave energy that appears on the transverse axis is direct evidence of rotational misalignment. The first-arriving compressional wave provides a clean optimization window because no other wave type is present during the interval between the compressional-wave first deviation and the arrival of slower waves. The iterative rotation refines the angular accuracy of the source-aligned coordinate system beyond what either the static gravity reading or the GNSS-derived geometry alone provides. In an array embodiment, as each additional penetrometer joins the array, additional source-aligned coordinate systems are established between the new penetrometer and each existing penetrometer within seismic range, producing additional constraints that the iterative refinement may use to further improve the orientation of every penetrometer in the array.

In one or more embodiments, an accelerometer of a penetrometer is calibrated for scale factor in-field at the time of deployment using local gravitational acceleration as a known reference. A Global Navigation Satellite System receiver of the penetrometer determines the penetrometer's geographic location to a precision of approximately two centimeters in horizontal coordinates and elevation. A control unit of the penetrometer, or a fog-layer computer in communication with the penetrometer, computes a local gravitational acceleration value from the penetrometer's geographic location using a geophysical model of Earth's gravity field. The geophysical model includes a normal-gravity formula that corrects for latitude (e.g., the WGS84 normal-gravity formula or equivalent) and a free-air correction or comparable correction for elevation, and may further include corrections for local geoid undulation or other local effects. In some embodiments, the geophysical model is a normal-gravity (ellipsoidal) formula that provides theoretical gravity as a function of position; in other embodiments a higher-degree spherical-harmonic geopotential model, a local gravity survey, or an absolute-gravimeter tie is used where greater reference accuracy is warranted. For deployment on another body, a corresponding planetary gravity model is used.

With the local gravitational acceleration value computed for the penetrometer's specific location, a static reading of the penetrometer's accelerometer during a quiet period yields a scale-factor calibration constant for each axis. The scale-factor calibration constant is the ratio of the computed local gravitational acceleration value to the static accelerometer reading expressed in the same units. The scale-factor calibration constant is applied to subsequent dynamic measurements of soil-propagating seismic waves recorded by the same penetrometer.

In a system embodiment comprising a plurality of penetrometers, each penetrometer determines its own scale-factor calibration constant based on its own geographic location and its own static accelerometer reading. The respective scale-factor calibration constants are applied to inter-penetrometer measurements including spatial attenuation, surface-wave dispersion, and amplitude-ratio analyses, producing array-wide amplitude consistency traceable to the geophysical gravity model.

In one or more embodiments, the system measures the ratio of compressional-wave propagation velocity to shear-wave propagation velocity across an array without requiring synchronization between sensors. Each sensor of a plurality of sensors at known distances from a seismic source detects, within a single record from a single impact event, a first arrival of a first wave type and a second arrival of a second wave type. Each sensor computes a differential arrival time Δt between the first and second arrivals using only its own internal clock. The differential arrival time at each sensor satisfies

$$Δ t = r \times ( \frac{1}{{V}_{2}} - \frac{1}{{V}_{1}} )$$

where r is the source-sensor distance, V₁ is the first wave type propagation velocity, and V₂ is the second wave type propagation velocity. The differential arrival times measured across the plurality of sensors are fit to a linear model of Δt versus r, with the slope equal to

$$( \frac{1}{{V}_{2}} - \frac{1}{{V}_{1}} ) .$$

The slope yields the ratio

$$\frac{{V}_{1}}{{V}_{2}} ,$$

which is a primary geotechnical soil property related to Poisson's ratio. With any single absolute velocity constraint, both absolute velocities are recovered. In an operational system with separate GPS-based time synchronization, the differential measurement provides an independent check on the absolute timing: any disagreement between the absolute and differential propagation velocity estimates flags a synchronization error or a soil heterogeneity in the propagation path.

In one or more embodiments, sensor data from a receiving penetrometer is processed using a multi-window stacking approach that produces a composite waveform representation by independently stacking different temporal segments of the recorded signals and compositing the stacked segments. A timing anchor is established by detecting a first sample at which the sensor signal deviates from a pre-impact baseline noise level by more than a threshold. The first deviation corresponds to a first arriving wave type of sufficient amplitude to exceed the threshold.

A plurality of time windows is defined relative to the timing anchor. A pre-arrival window of bounded duration precedes the timing anchor. The bounded duration is selected based on a maximum plausible velocity difference between the timing-anchor wave type and any earlier-arriving wave type, and the source-receiver distance. In a representative embodiment in a cohesive soil with a compressional-wave propagation velocity of approximately 270 to 290 meters per second and a slower wave type propagation velocity of approximately 130 to 160 meters per second, at a source-receiver distance of approximately 4 meters, a pre-arrival window of approximately 20 to 25 milliseconds provides margin to capture an earlier-arriving wave type together with a quiet baseline interval.

A first-arrival window is centered on or proximate to the timing anchor, with a duration that captures the peak of the timing-anchor wave type and any wave types arriving in temporal proximity. In one embodiment, the first-arrival window extends from approximately 5 milliseconds before the timing anchor to approximately 25 milliseconds after the timing anchor.

Additional sequential windows extend through subsequent portions of the recorded signals to capture later-arriving wave types and ring-down behavior. The sequential windows may overlap with one another to ensure continuous waveform coverage and to allow features that span window boundaries to be captured.

Within each of the plurality of time windows, sensor data is stacked across multiple impact events independently of the other windows. Each window produces a respective stacked output that improves signal-to-noise ratio for features in that temporal segment. The respective stacked outputs are then composited into a final waveform representation. The compositing combines the stacked outputs in a manner that reduces small time variances between the stacked segments while preserving wave-mode features that fixed-single-window stacking would obscure.

The pre-arrival window stack is particularly useful for recovering wave types that arrive before the timing-anchor wave type but with insufficient amplitude to be detected on any individual impact event. By anchoring the stack to a detectable later-arriving wave type rather than to the impact source trigger, the technique compensates for variability in source-trigger timing relative to wave propagation and accumulates pre-arrival signal coherently. The first-arrival window stack improves the signal-to-noise ratio of the peak amplitude features used for arrival-time picking. The sequential windows provide signal-to-noise improvement for ring-down behavior and for later-arriving wave types whose amplitudes would otherwise be dominated by the early portion of the waveform in a fixed-single-window stack.

The multi-window stacking approach is distinct from conventional stacking in that conventional stacking applies a single window across the full record of each impact event with a single alignment, typically the source trigger or the first detectable break of the record. The multi-window approach instead applies multiple separately-aligned stacks within the record and composites the results, producing a final waveform that captures wave-mode features that would be obscured by single-window stacking.

In a further embodiment, the same windowed-stacking approach is applied to a short-time Fourier transform analysis of the recorded seismic signals. Each window provides a separately-stacked input to the Fourier transform, with the result composited to produce a spectrogram with improved time-localization of frequency content relative to a fixed-window short-time Fourier transform applied uniformly across the record. The technique mitigates temporal smearing that arises when wave arrivals do not align with window boundaries in fixed-window analysis.

In one or more embodiments, generating composite waveforms further comprises detecting, in each individual seismic impact record, a first deviation from a baseline noise level of a first wave type having a first amplitude, defining a pre-arrival time window of bounded duration preceding the first deviation, and stacking sensor data within the pre-arrival time window across multiple impact events, aligned to the first deviation, to recover a second wave type having a second amplitude lower than the noise level of any individual impact record.

In one or more embodiments, a method comprises recording seismic signals at a receiving penetrometer in response to a plurality of impact events generated by a source penetrometer, detecting in the recorded seismic signals a first deviation from a baseline noise level of a detectable wave type where the first deviation establishes a timing anchor, and defining a plurality of time windows relative to the timing anchor. The plurality of time windows comprises a pre-arrival window of bounded duration preceding the timing anchor, a first-arrival window centered on or adjacent to the timing anchor, and one or more sequential windows extending through subsequent portions of the recorded seismic signals. The method further comprises stacking sensor data within each of the plurality of time windows independently across the plurality of impact events, producing a respective stacked output for each window, and compositing the respective stacked outputs into a final waveform representation.

In one or more embodiments, the stacking of the pre-arrival window recovers a wave type that is below the noise floor of any individual impact event. In one or more embodiments, the plurality of sequential windows comprise overlapping windows. In one or more embodiments, the compositing reduces small time variances between the stacked outputs while preserving wave-mode features that single-window stacking would obscure. In one or more embodiments, the windowed stacking is further applied to a short-time Fourier transform of the recorded seismic signals to produce a spectrogram with improved time-localization of frequency content relative to a fixed-window short-time Fourier transform of the same recorded seismic signals.

In one or more embodiments, a method comprises detecting, at a plurality of sensors at known distances from a seismic source, a first wave arrival of a first wave type and a second wave arrival of a second wave type, measuring at each sensor using only that sensor's internal clock a differential arrival time Δt between the first arrival and the second arrival, fitting Δt versus sensor distance to a linear model whose slope is

$$( \frac{1}{{V}_{2}} - \frac{1}{{V}_{1}} )$$

where V₁ and V₂ are propagation velocities of the first and second wave types, and computing the ratio

$$\frac{{V}_{1}}{{V}_{2}}$$

from the fitted slope without requiring synchronization between the plurality of sensors.

In one or more embodiments, generating composite waveforms further comprises computing, at each receiving penetrometer, a measured improvement in signal-to-noise ratio after each successive impact event, comparing the measured improvement against a threshold that is independent of theoretical VN scaling, and autonomously terminating impact accumulation when the measured improvement falls below the threshold.

In one or more embodiments, detecting a wave arrival comprises selecting a first sample at which the sensor signal deviates from a pre-arrival baseline noise level by more than a threshold, rather than selecting a peak amplitude sample.

In one or more embodiments, detecting seismic waves comprises recording sensor data on each of three orthogonal axes of a three-axis accelerometer, analyzing each axis independently to extract wave-mode-specific features that are obscured by a root-sum-of-squares composite of the three axes, and determining a radial axis, a transverse axis, and a vertical axis through a rotation of the three orthogonal axes determined from at least one of (i) a static gravity reading, (ii) a polarization of a first-arriving compressional wave, and (iii) an iterative rotation that minimizes compressional-wave energy on the transverse axis.

In one or more embodiments, a penetrometer comprises a single inertial measurement unit configured to produce, during a single insertion event, sensor data from which a control unit derives at least three of the following: acceleration spectra of soil-propagating seismic waves; particle velocity by integration of acceleration; penetration depth by double integration of acceleration; soil resistance from distance per impact; rotational rate from a gyroscope channel of the inertial measurement unit; and orientation of the penetrometer relative to local gravity from a static reading of the inertial measurement unit.

In one or more embodiments, a method comprises determining a geographic location of a penetrometer using a Global Navigation Satellite System receiver where the location comprises latitude, longitude, and elevation, computing a local gravitational acceleration value from a geophysical model of Earth's gravity field where the local value is corrected for elevation using a free-air or comparable correction, recording a static accelerometer reading from the penetrometer in a quiet period, and computing a scale-factor calibration constant for each axis of the accelerometer based on the static reading and the computed local gravitational acceleration value. The scale-factor calibration constant is applied to subsequent dynamic measurements of soil-propagating seismic waves recorded by the same penetrometer.

In one or more embodiments, a respective scale-factor calibration constant is computed for each of a plurality of penetrometers in a deployed array, with each penetrometer's local gravitational acceleration value computed from its own GNSS-determined location. The respective scale-factor calibration constants are applied to inter-penetrometer measurements including spatial attenuation and surface-wave dispersion to produce array-wide amplitude consistency traceable to the geophysical gravity model.

In one or more embodiments, a method comprises recording acceleration data from an accelerometer mounted on a penetrometer during a plurality of impact events that drive the penetrometer into a soil, computing a per-impact penetration distance by double integration of the acceleration data, computing a soil resistance value from the per-impact penetration distance and a known impact energy, and calibrating the soil resistance value against a reference dynamic cone penetrometer at the deployment site.

In one or more embodiments, a method further comprises recording surface-wave arrivals at a plurality of penetrometers at known relative positions, extracting a surface-wave dispersion curve from the recorded arrivals, and inverting the dispersion curve to produce a depth-resolved shear-wave velocity profile of the soil beneath the array.

Multiple embodiments are described herein, including the best mode known to the inventors for practicing the claimed invention. Of these, variations of the disclosed embodiments will become apparent to those of ordinary skill in the art upon reading the foregoing disclosure. The inventors expect skilled artisans to employ such variations as appropriate (e.g., altering or combining features or embodiments), and the inventors intend for the invention to be practiced otherwise than as specifically described herein. In addition, while the invention has been described in terms of several preferred embodiments, it should be understood that there are many alterations, permutations, and equivalents that fall within the scope of this invention. It should also be noted that there are alternative ways of implementing both the process and apparatus of the present invention. For example, steps do not necessarily need to occur in the orders shown in the accompanying figures and may be rearranged as appropriate. It is therefore intended that the appended claims include all such alterations, permutations, and equivalents as fall within the true spirit and scope of the present invention

While the present invention is capable of being embodied in various forms, for simplicity and illustrative purposes, the principles of the invention are described by referring to certain embodiments thereof. It is understood, however, that the present disclosure is to be considered as an exemplification of the claimed subject matter and is not intended to limit the appended claims to the specific embodiments illustrated. It will be apparent to one of ordinary skill in the art that the invention may be practiced without limitation to these specific details. In other instances, well-known methods and structures have not been described in detail so as not to unnecessarily obscure the invention. For example, while embodiments herein are described with reference to high-frequency remote surveying, it is understood that the systems and methods may be implemented similarly with respect to remote surveying more generally.

The terminology used in the present disclosure is for the purpose of describing particular embodiments only and is not intended to limit the present disclosure. As used in the present disclosure and the appended claims, the singular forms “a,” “an,” and “the” are intended to include the plural forms as well, unless the context clearly indicates otherwise. It shall also be understood that the terms “and” and “or” used herein is intended to signify and include any or all possible combinations of one or more of the associated listed items. As used herein, the term “if” may be understood to mean “when” or “upon” or “in response to a judgment” depending on the context.

The present disclosure relates to high-frequency remote surveying. In one or more embodiments, the high-frequency remote surveying system is used for large-scale surveying of hazardous sites. Conventional systems assume uniform soil characteristics rather than measuring them locally, rely on centralized processing that creates bandwidth bottlenecks and single points of failure, and cannot adequately extract weak signals from background noise. The disclosed system overcomes these challenges through a distributed autonomous sensor mesh architecture in which penetrometers function as autonomous computational nodes capable of peer-to-peer communication and computation without requiring centralized coordination. The system employs temporal oversampling with statistical aggregation of 64 or more hammer impacts to dramatically improve signal-to-noise ratios, enabling detection of weak subsurface signals that would otherwise be indistinguishable from noise. Real-time hyperlocal seismic property measurement with continuous recalculation achieves velocity precision of approximately, for example, 0.01% (100 parts per million), enabling detection of anomalies as small as 0.5-2%—an order of magnitude smaller than natural soil heterogeneity variations (typically 5-10%). The fault-tolerant architecture scales to 100 or more penetrometers, continues operating despite loss of individual nodes, and enables operation in communications-denied environments. Multi-modal deployment flexibility through platform-agnostic penetrometer design with self-righting capability enables sensor placement via aerial vehicles, ground vehicles, or manual installation, providing access to difficult terrain inaccessible to conventional ground-vehicle-only systems. This distributed approach enables comprehensive subsurface investigation across vast, inhospitable areas while detecting objects spanning multiple orders of magnitude in size through dual-wave detection of both high-frequency P-waves for landmine-scale resolution and lower-frequency S-waves for larger unexploded ordnance. In one or more embodiments, the system is used for identifying Explosive Remnants of War (ERW), such as unexploded ordnance, land mines, or improvised explosive devices, which continue to pose significant dangers in post-conflict zones such as the Zone Rouge in France.

In one or more embodiments, the remote surveying system uses the penetrometers' on-board seismic sources, instrumentation, and computing power to calculate the local soil's seismic properties between each pair of penetrometers. By placing two penetrometers at known locations and with both having access to precise timing signals and commanding one to generate a seismic stimulus, the system can calculate the soil's seismic velocity and attenuation coefficient. The seismic wave velocity is critical to calculating the size of an anomaly detectable by a specific frequency. For example, if the seismic velocity is 200 meters per second and the frequency is 2,000 Hz, the smallest detectable anomaly would be 0.1 meters, or 10 centimeters, in any dimension. These properties also include the soil's seismic wave attenuation characteristics as a function of both distance and of frequency or dB-cm₋₁-kHz⁻¹. The on-board system can calculate a maximum distance a detectable seismic wave of a particular frequency may travel using those attenuation characteristics with the seismic stimulus output power and the instrumentation sensitivity.

In one or more embodiments, the remote surveying system generates a map of the survey site showing penetrometer locations together with the calculated soil parameters between penetrometers, and as interpolated between calculated locations.

In one or more embodiments, the remote surveying system uses the map of the survey site to generate a penetrometer array configuration for maximum penetrometer spacing, or high productivity, while also meeting minimum size object detection goals within the limits of the local soil's seismic characteristics and penetrometer capabilities. This may be achieved through the “round trip” distance a wave must travel from the penetrometer to the object to the penetrometer or the “one way distance” from the penetrometer to the object to a second penetrometer.

In one or more embodiments, the remote surveying system continuously adjusts the penetrometer array configuration to accommodate new information. Potential anomalies might be designated for additional investigation by adding penetrometers to the array closer to the potential anomaly, for example.

In one or more embodiments, the remote surveying system utilizes seismic frequencies ranging from 1,000 Hz to 20,000 Hz. For instance, 2,000 Hz waves can be used over distances of approximately 5 meters, depending on soil conditions, seismic stimulus power, the instrument sensitivity, the seismic velocity, and the attenuation of the seismic wave over distance. This frequency provides acceptable readings for detecting anomalies while balancing penetration depth and resolution. The effective distance for a given frequency depends on the local soil's seismic velocity and attenuation characteristics, which can be measured using two penetrometers. By placing two penetrometers at known locations and having one generate a seismic stimulus, the system can calculate the soil's seismic velocity and attenuation coefficient. These parameters are used for optimizing penetrometer spacing and interpreting the received signals.

For higher frequency sensing, the system employs more sophisticated techniques. This involves using a high-power, directional seismic source in one penetrometer, aimed towards another. Unlike the broadband energy produced by a hammer impact, this source concentrates energy at a single frequency, similar to a loudspeaker but for seismic waves. This approach allows for higher resolution imaging but over shorter distances. The system dynamically adjusts penetrometer locations based on the expected size of potential threats and the desired survey productivity.

The precise timing and location data from each penetrometer, combined with advanced edge processing capabilities, enable the calculation of several critical parameters. These include the time-of-flight of seismic waves between penetrometers, which is used to compute soil velocity; the amplitude decay of waves over distance, used to determine the attenuation coefficient; and the precise location and characteristics of subsurface anomalies. For example, if a seismic wave takes 10 milliseconds to travel between two penetrometers spaced 2 meters apart, the system can calculate a nominal soil velocity of 200 m/s which would include some uncertainty for the first calculation. Additional measurements would quickly resolve the soil velocity to a precise value. Actual soil seismic velocities are expected to fall within a general range from 100 to 250 m/s.

Turning now to the figures, FIG. 1 shows a remote surveying system 10, according to an embodiment of the present disclosure. The remote surveying system 10 includes a remote analysis facility (RAF) 12 with an internal database 14, local facility 15, at least one penetrometer 16, a mobile unit 18, a network 20, and an external database 22. The RAF 12 is able to communicate with the local facility 15 and external database 22 through the network 20. The local facility 15 can communicate with the penetrometer 16 and mobile unit 18 through wireless communication or a local wireless network. The RAF 12 can be a remote central analysis and control system or part of a cloud platform that runs software for extended analysis of the surveying data.

The local facility 15 serves as an on-site operational hub for the remote surveying system 10. Located in proximity to the area being surveyed, it acts as an intermediary between the RAF 12 and the field equipment, including the penetrometers 16 and mobile units 18. The local facility 15 is equipped with local computing power such as a high-performance server or small cluster of computers capable of near real-time data processing, temporary data storage, and running complex algorithms for initial data analysis. The computing resources at the local facility enable it to perform tasks such as data compression, noise filtering, and preliminary anomaly detection, reducing the amount of raw data that needs to be transmitted to the RAF 12. This local processing capability also allows for rapid decision-making in response to field conditions, such as adjusting penetrometer placement or mobile unit paths based on initial and ongoing findings. The local facility 15 further includes communication systems that allow it to receive instructions from the RAF 12 via the network 20 and relay these commands to the field equipment using wireless communication or a local wireless network. It also collects and preprocesses data from the penetrometers 16 and mobile units 18 before transmitting it back to the RAF 12 for comprehensive analysis. This local facility can house maintenance equipment, spare parts, and potentially a team of technicians to manage and service the field equipment, ensuring continuous and efficient operation of the surveying system. By having this local presence, the system can respond quickly to changing conditions without requiring constant direct communication between the field equipment and the distant RAF 12.

The RAF 12 is an operational hub of the remote surveying system, integrating advanced data processing capabilities with human oversight functions. Located in a secure facility away from hazardous survey areas, the RAF houses powerful computing resources, sophisticated analysis software, and operator workstations. It receives raw and processed data from the field deployed penetrometers and further processes that data, utilizing processes and algorithms to detect, characterize, and precisely locate subsurface objects. The RAF coordinates the overall survey strategy. By combining automated analysis with human decision-making capabilities, the RAF enables efficient, safe, and accurate subsurface surveying across large areas, while maintaining the flexibility to adapt to complex scenarios that require human judgment. The RAF communicates with an internal database 14 that stores and manages vast amounts of data gathered from penetrometers, survey area characteristics, outside sources such as combat records or unit histories, detailed descriptions of various types of ordnance and landmines, satellites, and operational parameters. This database not only archives raw sensor data but also supports the system's processing algorithms, storing intermediate results, and analysis outputs. By leveraging this comprehensive data repository, the RAF can perform real-time analysis, historical comparisons, and predictive modeling to enhance the accuracy and efficiency of the survey process.

The penetrometer 16 is a sophisticated sensing device that serves as the primary data collection tool in the remote surveying system 10. Designed for insertion into the ground at predetermined locations across the survey area, the penetrometer combines multiple functions in a single, modular unit. It includes a dynamic penetration mechanism, featuring an internal recoilless hammer that drives the device into the soil while simultaneously generating seismic waves. The penetrometer is equipped with an array of high-sensitivity sensors, including accelerometers, geophones, and microphones, capable of detecting seismic frequencies ranging from 1,000 Hz to 10,000 Hz. This would allow for the detection and characterization of very small objects. As it penetrates the ground, the device continuously measures soil resistance and captures reflected seismic waves from subsurface objects or layers. The penetrometer also incorporates precise location, time, and orientation sensors, ensuring accurate geospatial data for each measurement. All collected data is transmitted in real-time to the Local Facility and RAF through, for example, a mesh network communication system, enabling immediate processing and analysis. The network also allows penetrometer-to-penetrometer communication for coordinated measurements of the local soil's seismic velocity and attenuation characteristics to facilitate optimal penetrometer installation, operation, removal, and reuse. This innovative design makes the penetrometer an essential tool for efficient, safe, and accurate subsurface surveying, particularly in hazardous areas.

The mobile unit 18 is designed to transport and deploy penetrometers across the survey area with minimal human intervention. The mobile unit 18 can include an Uncrewed Ground Vehicle (UGV), an Uncrewed Aerial Vehicle (UAV), or an Uncrewed Water Vehicle (UWV), which serves as a versatile and autonomous platform for penetrometer placement operations. This mobile unit 18 is equipped with advanced navigation systems, including GPS and obstacle detection sensors, allowing it to traverse challenging terrains safely and efficiently. The mobile unit 18 features a specialized payload system for storing multiple penetrometers and a mechanism for precise penetrometer deployment.

The external database 22 is a versatile and scalable component of the remote surveying system, designed to augment the capabilities of the RAF. This database can be implemented as a dedicated server or a cloud computing platform, providing additional storage capacity to support the surveying operations. It serves as a centralized repository for a wide range of data relevant to the survey area, including historical and geological information, satellite imagery, previous survey results, and known hazard locations. The external database can also host specialized algorithms or machine learning models that may require more extensive computational resources than available in the field-deployed local facility. By leveraging cloud computing capabilities, the system can perform complex analyses, run simulations, or process large datasets without impacting the real-time operations at the local facility. Additionally, the external database facilitates data sharing and collaboration with other agencies or research institutions, allowing for the integration of diverse data sources to enhance the accuracy and comprehensiveness of the subsurface surveys. This external resource significantly expands the system's analytical capabilities and flexibility, enabling more informed decision-making and improved survey outcomes.

In an embodiment, the remote surveying system 10 operates by first deploying an uncrewed ground vehicle 18 to strategically place high-frequency sensors 16 across a survey area. Initial readings are then taken and analyzed by the penetrometer edge processor(s) to identify areas of interest or potential anomalies. Based on this analysis, additional sensors 16 are precisely positioned to further investigate specific objects or regions, allowing for detailed mapping and characterization of subsurface conditions through iterative surveying and data fusion.

In one or more embodiments, the Local Facility 15 is the brain of the site examination automation process and allows for high level of automation that makes the remote surveying system safe, effective, and economical. The local facility's operational cycle includes (1) a detailed map of the area to be surveyed; (2) a “first cut” set of penetrometer locations based on the map data; (3) the penetrometer locations are used to calculate a penetrometer installation cycle beginning with the first penetrometer to be installed; (4) the penetrometer installation cycle is used to calculate a path plan for the equipment bringing the penetrometers to their installation locations; (5) the seismic data from all penetrometers, and beginning with the first one, is used to verify that the path to and installation of the next penetrometer in the plan is within site safety rules. The system uses seismic data from installed penetrometers to verify safety for deploying the next one. It checks both the path to the installation site and the site itself against predefined safety rules. This process is repeated for each new penetrometer, ensuring continuous safety assessment throughout the deployment based on real-time seismic data; (6) if a potential safety hazard is identified that would endanger the penetrometer placement equipment, the local facility software replans the equipment's route for both safety and for close inspection of the possible safety hazard; (7) the baseline for close inspection is for the local facility to calculate the locations for added penetrometers placed sequentially closer to the possible safety hazard; (8) the remote analysis computers use this combination of close inspection, data from high-frequency seismic instrumentation in the instrumented penetrometer, and multiple sensor locations around the suspected safety hazard to calculate a 3-dimensional, or 3-D, image of the suspected safety hazard that is akin to an ultrasound image; (9) close inspection can also be accomplished by using other sensors, such as a ground penetrating radar (GPR) on a specialized uncrewed vehicle, but the detailed analysis of the data remains at the remote analysis facility and the general process of developing a 3-D image remains the same; (10) the remote analysis system then compares the 3-D image of the suspected safety hazard with 3-D solid models of safety hazards of similar size to both characterize and precisely geolocate it; (11) the remote analysis system then classifies the identified potential safety hazard as either non-hazardous or potentially hazardous and requiring intervention by technicians or other personnel; (12) the full analysis of the potential safety hazard is provided to the technicians assigned to remediate or mitigate the hazard; (13) the technicians then report their findings for recording on the system for later processing.

In an embodiment, a detailed map is obtained from outside sources and downloaded through the RAF. In another embodiment, when no sufficient map is available a map can be created, for example, by an UAV equipped with a suitable camera combined with photogrammetry software in the local facility. The map can then be uploaded to the RAF.

In an embodiment, the RAF can be configured to analyze the penetrometer data by combining it with other information such as notes or maps. The RAF may use the results of this data fusion process to develop higher value analysis results such as the most likely artifact type to exist within a given subsurface anomaly by matching those results with computer models, photographs, or detailed descriptions of the ordnance likely to have been used during combat at the site. This information may make the process of eliminating the threat posed by the subsurface artifact safer and less time consuming.

In an embodiment, the remote surveying system includes a human control center that serves as the central hub where operators monitor automated equipment and respond to off-nominal situations. Its staffing level correlates with the number of operational sites and site-specific hazards. This center can be situated anywhere with appropriate office space, utilities, and internet connectivity, offering flexibility in its location.

In an embodiment, the local facility is strategically positioned away from hazardous inspection areas. It functions as a maintenance and support base for the uncrewed vehicles and instrumented penetrometers, housing a well-equipped shop area and maintaining a substantial inventory of parts and supplies.

In an embodiment, the local facility can do “site level” computing: edge in the penetrometer, “Site Level or Fog Layer” in the local facility, the heavy duty computational load of understanding what the threats are in the Remote Analysis Facility. Together, these facilities ensure efficient, safe, and well-supported operations for the remote surveying system across various deployment scenarios. The RAF can control as many sites as needed. It can share new knowledge across sites as soon as it is created. More sites worldwide can include more workstations, and possibly virtual machines, in the RAF.

In an embodiment, the remote surveying system employs a hierarchical processing structure to efficiently manage data collection, analysis, and decision-making. This structure consists of three primary layers: edge processing, local processing (fog layer), and the Remote Analysis Facility (RAF) or cloud layer.

At the ground level, mobile vehicles (ground, air, and water-based) equipped with various sensors and edge computing capabilities navigate the survey area, detect potential threats, and deploy penetrometers. These vehicles continuously transmit their situational awareness data to the local facility. The penetrometers, featuring internal hammers and potentially other noise-generating mechanisms (akin to loudspeakers), conduct seismic surveys and perform initial data processing. Their edge computing power allows for real-time measurement of local soil characteristics and preliminary threat detection, with this processed data being sent to the local facility.

The local facility, positioned as an intermediary between the field equipment (mobile vehicles and penetrometers) and the RAF, serves as the system's fog layer. This facility houses significant computing resources to perform data fusion from all penetrometers, enabling more comprehensive threat identification. It also manages the deployment strategy for the penetrometer array, determining optimal placement for new units and identifying when existing penetrometers should be retrieved for redeployment. This local processing is used for maintaining the efficiency and effectiveness of the ongoing survey operation.

In one or more embodiments, the RAF can be configured to analyze the penetrometer data by combining it with other information sources. These sources may include combat records and unit histories, which provide context about the types of military activities that occurred in the surveyed area. The system also incorporates detailed descriptions of various types of ordnance and landmines, allowing for more accurate identification of detected objects. Satellite imagery can be used to correlate subsurface findings with surface features or historical changes in the landscape. Operational parameters from past and current surveying missions are also considered to refine the analysis process. The RAF may use the results of this data fusion process to develop higher value analysis results, such as determining the most likely artifact type to exist within a given subsurface anomaly by matching those results with computer models, photographs, or detailed descriptions of the ordnance likely to have been used during combat at the site. This comprehensive approach to data analysis enhances the system's ability to accurately identify and characterize potential threats, making the process of eliminating the threat posed by the subsurface artifact safer and less time consuming.

In one or more embodiments, each penetrometer is equipped with multiple sensors arranged in different orientations or positions within the housing. This configuration allows a single penetrometer to detect the direction from which seismic waves are received, enhancing its ability to contribute to precise localization of subsurface anomalies.

In one or more embodiments, the system employs a distributed autonomous sensor mesh architecture in which each penetrometer functions as an autonomous computational node capable of peer-to-peer communication and computation without requiring centralized coordination. Each penetrometer broadcasts its composite waveform data, including wave arrival time, amplitude, and temporal attenuation, along with its precise location to other penetrometers in the network. Upon receiving broadcasts from neighboring penetrometers, each penetrometer autonomously calculates seismic velocity and spatial attenuation coefficients between itself and its neighbors. This distributed approach enables the array to function as a self-organizing computational mesh where collective behavior emerges from peer interactions rather than central control, providing fault tolerance and scalability to 100 or more penetrometers. The fault-tolerant design ensures that loss of individual penetrometers or fog_0 nodes does not disable the array, as the system continues operating with remaining nodes. This architecture also enables operation in communications-denied environments where centralized infrastructure may be unavailable or compromised.

In one or more embodiments, the system employs temporal oversampling with composite waveform generation to improve signal-to-noise ratios for detecting weak subsurface signals. This approach implements a statistical radar concept using acoustic waves with temporal oversampling analogous to radar processing. The seismic wave generator in a source penetrometer produces multiple hammer impacts at known times, and sensor data from receiving penetrometers is time-aligned via GPS-synchronized timing signals. Composite waveforms are generated locally at each penetrometer through statistical aggregation of sensor data across the multiple impact events, dramatically improving the signal-to-noise ratio and enabling detection of weak reflected signals that would otherwise be indistinguishable from background noise. Test data supports aggregation of 64 or more hammer impacts for high quality composite waveform generation, with arrival time precision improving by a factor of 8× with 64 or more hammer impacts. Each penetrometer outputs composite waveform data along with extracted parameters such as wave arrival time, amplitude, and temporal attenuation, rather than transmitting raw sensor data. By transmitting composite waveform data and extracted parameters rather than raw sensor data, the system avoids bandwidth bottlenecks when scaling to large numbers of penetrometers.

In one or more embodiments, the system employs adaptive power management via distributed commanding to extend operational duration. Each receiving penetrometer calculates signal-to-noise ratio as composite waveforms are generated and autonomously commands the source penetrometer to continue hammer action if the signal-to-noise ratio is improving above a threshold. This hierarchical decision-making approach combines local rules-based decisions for fast response with strategic decisions for resource allocation, concentrating power expenditure only where detection remains ambiguous and extending battery life during multi-day operations. Adaptive commanding may extend operational duration by a factor of 3 to 5 compared to fixed stimulus protocols.

In one or more embodiments, the system detects subsurface anomalies through seismic property discontinuity detection. As the penetrometer array grows incrementally, the system builds a spatial map of seismic velocity and attenuation values across the survey area. The system identifies discontinuities where seismic velocity or attenuation between one penetrometer pair differs significantly from neighboring pairs by more than a threshold percentage. These discontinuities are flagged as locations of interest requiring closer inspection, as they may indicate the presence of voids, dense objects, disturbed soil, or layer boundaries. This approach complements tomographic imaging by providing faster detection with fewer penetrometers and guiding strategic array expansion.

In one or more embodiments, the system detects multiple wave types to enable detection of objects spanning a wide range of sizes. The system detects high-frequency waves, such as primary compressional waves at approximately 1 kHz, which provide resolution suitable for detecting landmine-sized objects with dimensions on the order of 10 to 20 centimeters. The system also detects lower-frequency waves, such as secondary shear waves at approximately 100 to 200 Hz, which enable detection of larger unexploded ordnance with dimensions greater than 50 centimeters. This dual-wave detection capability allows a single sensor array to replace multiple specialized detection technologies, enabling threat detection spanning multiple orders of magnitude in object size.

In one or more embodiments, the system supports multi-modal deployment flexibility through a platform-agnostic penetrometer design. The penetrometer may include a ground contact blade or gyroscope configured to self-right the penetrometer when dropped from a height of at least one meter, and a housing configured to withstand impact forces from such a drop. The control unit may be configured to autonomously initialize upon detecting ground contact. This design enables deployment by multiple methods including unmanned aerial vehicle delivery for difficult terrain such as steep slopes, crater-pocked areas, forested regions, or areas with unstable ground, as well as robotic placement via ground vehicles and manual installation by personnel.

In one or more embodiments, the system performs real-time hyperlocal seismic property measurement with continuous recalculation as new penetrometers are added to the array. Seismic velocity and attenuation coefficients are recalculated in near real-time as the array expands, and penetrometer spacing is dynamically adapted based on updated measurements. Properties are mapped at resolutions ranging from 0.5 to 10 meters rather than assumed uniform across the survey area. Temporal oversampling with 64 or more hammer impacts combined with measurements from multiple penetrometer pairs provides combined precision of approximately 0.01% (100 parts per million) in seismic velocity. In operational deployment, multiple source penetrometers create overlapping ray path coverage through the subsurface, with typical arrays placing multiple ray paths through each cubic meter of subsurface volume. This tomographic overdetermination enables the system to constrain velocity estimates with precision of 0.03-0.1% (300-1000 parts per million) in individual voxels. When combined with spatial gradient analysis across multiple voxels, the system can reliably detect velocity anomalies as small as 0.5-2%, which is an order of magnitude smaller than natural soil heterogeneity variations (typically 5-10%).

In one or more embodiments, the system employs a hierarchical fog architecture with specific functional allocation across processing layers. At the Edge layer, each penetrometer performs composite waveform generation and temporal attenuation calculation, with any pair of penetrometers capable of seismic velocity calculation and spatial attenuation coefficient calculation. At the Fog_0 layer, which may be implemented on mobile robots, the system performs suspect soil properties detection, initial tomographic imaging, adaptive commanding, and mission coordination. At the Fog_1 layer, implemented at the site facility, the system performs full 3D reconstruction, AI threat identification, and digital twin creation and revision. At the Cloud layer, the system performs full site tomography for enhanced digital twin generation, maintains a database of tomographic images versus ground truth for improved identification, and enables worldwide threat data sharing across multiple survey sites.

### High-Frequency Surveying

In one or more embodiments, the system utilizes penetrometers capable of detecting frequencies much higher than traditional seismic equipment, potentially up to 60,000 Hz, which allows for the detection and characterization of smaller objects and finer subsurface features. Unlike traditional geophones that may operate at frequencies 1 to 5 Hz, this system incorporates sensors capable of detecting seismic waves at frequencies as high as 60,000 Hz. This dramatic increase in frequency range allows for the detection and characterization of much smaller subsurface objects-down to 3 millimeters in size, compared to the meter scale of conventional systems. The higher frequencies provide significantly improved resolution, analogous to the difference between low and high-resolution imaging in other fields. This enhanced capability is achieved through a combination of highly sensitive sensors, continuous calculation of the local soil characteristics, advanced signal processing techniques, precise placement for each individual penetrometer based on soil characteristics and selected threat size limits, and the strategic sensor placement within the penetrometer. The system's ability to both generate and detect high-frequency seismic waves enables the RAF to create detailed, three-dimensional subsurface images, analogous to medical ultrasound technology. This high-frequency approach, coupled with the penetrometer's unique design for in-situ soil measurements, allows for unprecedented accuracy in identifying and characterizing small subsurface anomalies or artifacts, making it particularly valuable for applications such as unexploded ordnance detection or precise geological surveys in challenging environments. The artifacts can include items ranging from hand grenades to 250 lb bombs to sewer pipelines.

### Penetrometers

FIG. 2 shows a penetrometer 100, according to an embodiment of the present disclosure. The penetrometer 100 includes a placement interface 112, control unit 114, data buffer and transmission unit 116, battery 118, data acquisition unit 120, geophone 122, instrumentation 124, gyroscope 125, internal recoilless hammer 128, and penetrator 130. The placement interface 112 allows for easy handling and deployment by uncrewed vehicles or other placement systems. The control unit 114 provides edge computing and coordinates operations and communications within the penetrometer. This unit manages system initialization, sensor operations, data preprocessing, power management, and communication protocols. It interfaces with the data acquisition unit 120, which collects readings from the geophone 122, instrumentation 124, and gyroscope 125. These sensors provide crucial data on seismic waves, orientation, and subsurface soil characteristics. The penetrometer will also get data from a Global Navigational Satellite System (GNSS) [GPS is a part of that] with Real Time Kinematic (RTK) correction. This is where the precise location and time signals come from.

The internal recoilless hammer 128 serves a dual purpose: it drives the penetrometer into the ground during installation and generates seismic waves for surveying. The penetrator 130 is the physical interface with the soil, designed for optimal penetration and seismic wave transmission. The gyroscope 125 ensures the penetrometer maintains proper orientation during installation. All collected data is temporarily stored in the data buffer and transmission unit 116 before being sent to the local facility for processing and upload to the RAF.

The battery 118 powers all onboard systems, with its usage optimized by the control unit 114. The placement interface 112 is designed for compatibility with mobile unit or other deployment systems, facilitating easy handling and precise positioning. All these components work in concert, communicating through internal protocols managed by the control unit 114. The penetrometer operates as part of a larger network, sending data to and receiving commands from the local facility, which coordinates the overall survey operation. This integrated approach allows for adaptive, real-time surveying strategies based on the data collected and analyzed across multiple penetrometers in the field.

In one or more embodiments, the seismic energy is generated using recoilless hammers and/or noisemakers (such as a loudspeakers) that are oriented horizontally and can be commanded to operate at specific frequencies.

In one or more embodiments, the penetrometer combines seismic source and sensor capabilities in a single unit, featuring multiple high-frequency sensors capable of detecting up to 60,000 Hz, far exceeding conventional 1 to 5 Hz geophones. Its dynamic design allows for self-installation using an internal recoilless hammer positioned at the penetrator tip, with gyroscopic stabilization ensuring vertical alignment. This configuration enables precise seismic impacts while minimizing shock to other components. The device can also be installed conventionally using an external hammer if needed.

The penetrometer's versatility extends beyond installation, as it can generate seismic waves post-installation and incorporates high-precision location and time instrumentation. Its modular design adapts to various site conditions and accommodates different placement systems. On-board electronics handle data acquisition and conversion, while mesh network capabilities enable remote command reception and data transmission. A magnetic interface facilitates efficient handling by uncrewed vehicles, enhancing overall system productivity and flexibility in deployment scenarios.

The data acquisition unit 120 interfaces directly with the sensors, including the geophone 122, which detects seismic waves, and internal instrumentation 124 such as Global Navigation Satellite System (GNSS) for precise geographic location and time, angle sensors, accelerometers and microphones for high-frequency detection.

A gyroscope 126 maintains the penetrometer's vertical orientation during installation and operation. The internal recoilless hammer 128 serves a dual purpose: it drives the penetrometer into the ground and generates seismic waves for subsurface analysis. Finally, the penetrator 130 at the base of the device is designed to efficiently enter the soil while housing sensors for direct contact with the subsurface environment.

In an embodiment, the integrated system allows the penetrometer to simultaneously install itself, generate seismic waves, collect high-resolution data about the subsurface, and transmit this information for immediate analysis, making it a powerful tool for comprehensive and efficient subsurface surveys.

FIGS. 3A and 3B show penetrometers 200A, 200B, according to embodiments of the present disclosure. The penetrometer 200A can include a body 242A that is solid. The penetrometer 200B can also be an extendable body with walls 242B and 244B. In FIG. 3A, the penetrometer 200A features a solid body 242A, offering enhanced structural integrity, improved resistance to impact forces during installation, and better protection for internal components against harsh environmental conditions. This solid design may provide superior heat dissipation and simplified manufacturing but could limit adaptability to uncrewed vehicle penetrometer handling systems' kinematic limitations. In FIG. 3B, the penetrometer 200B utilizes an extendable body with walls 242B and 244B, employing a telescoping mechanism. This design allows for adjustable length, accommodating various uncrewed vehicle kinematic needs and soil depths and conditions, while also enabling compact storage and transportation when retracted. The extendable configuration offers greater flexibility in deployment scenarios, especially in confined spaces, and potentially allows for reaching greater depths than a fixed-length design.

FIGS. 4A, 4B, and 4C shows various placement interface designs (312A, 312B, 312C) for penetrometers according to embodiments of the present disclosure. These interfaces are engineered to facilitate efficient and secure handling by robotic arms or other mechanical placement devices. In FIG. 4A, the placement interface 312A features a solid, flat surface compatible with suction devices or magnetic plates, offering a simple yet effective connection method. FIG. 4B showcases placement interface 312B with curved sections 313B, specifically designed to accommodate gripping components for secure attachment to placement mechanisms. FIG. 4C presents a more intricate design in placement interface 312C, incorporating a central void 313C that allows for easy handling by human beings. Each of these designs is tailored to optimize the interaction between the penetrometer and its deployment system, ensuring precise positioning and efficient installation across various operational scenarios and environments.

FIGS. 5A, 5B, and 5C illustrate three distinct penetrator interface designs (430A, 430B, 430C) for the penetrometer system, each tailored to specific soil conditions and penetration requirements. The flat structure 430A features a flat end 432A, suitable for softer soils where increased resistance to installation is desired for added seismic energy generation. The round tip structure 430B with its curved end 432B offers customized penetration resistance for a variety of soil types. The conical tip structure 430C, ending in a pointed tip 432C, is designed for maximum penetration capability, particularly effective in harder or more compact soil conditions. These varied designs enable the penetrometer system to adapt to diverse geological environments, optimizing its effectiveness across different deployment scenarios.

FIG. 6 shows a mobile unit 500 according to an embodiment of the present disclosure. The mobile unit 500 is an uncrewed ground vehicle with a motor 510, tires 511, an arm 512, a quiver 514, a first penetrometer 516, an engage unit 518, and a second penetrometer 520. The motor 510 is used to power tires 511 for traveling through ground terrain. The quiver 514 is a container designed to hold multiple penetrometers while the mobile unit 500 travels to place the penetrometer. The quiver 514 is also designed to allow the penetrometer to be accessed and removed for placing the penetrometer on the ground but also for accepting the penetrometer when picked up by the mobile unit 500. The first penetrometer 516 is located in the quiver 514 and can be removed for surveying. The engage unit 518 is designed to connect the penetrometer to the arm for placing and releasing the penetrometer whether on the ground or back in the quiver 514. The engage unit 518 can be a gripping mechanism, magnetic mechanism, air pressure mechanism, or other mechanism for connecting to and moving the penetrometer. The second penetrometer 520 is connected to the engage unit 518 and can be placed in the ground or into the quiver 514.

In one or more embodiments, the mobile unit 500 includes a diverse range of uncrewed vehicles (ground, water, and air) for installing instrumented penetrometers, maximizing efficiency through full automation. The mobile unit 500 can significantly reduce inspection costs, eliminate human exposure to hazardous objects, and enable exploration of remote sites, including lunar locations. Ground vehicles (wheeled, tracked, or legged) are selected based on site conditions, with wheeled options preferred for productivity and cost-effectiveness. Water vehicles, designed for shallow operations, serve in swampy or marshy areas. Air vehicles, typically handling one penetrometer at a time via electromagnet, offer precise placement capabilities and access to locations that may be inaccessible to ground vehicles and locations with only a small area to be searched. Human involvement is limited to logistical tasks such as unpacking, initialization, loading, maintenance, and repacking of penetrometers, ensuring a balance between automation and necessary manual oversight.

FIG. 7 shows a hammer-generated seismic energy map 600, according to an embodiment of the present disclosure. The map includes a penetrometer 612, seismic waves 614, subsurface anomaly 616, reflected seismic waves 618, previously emplaced penetrometer 620, and primary penetrometer 622. The penetrometer 612 generates seismic waves 614 that propagate through the surrounding medium. These waves interact with a subsurface anomaly 616, producing reflected and refracted seismic waves 618 that are detected by both the originating penetrometer 612 and a previously emplaced penetrometer 620. The primary penetrometer 622 is able to read the reflected seismic energy and can serve as a reference point. This visualization demonstrates the system's ability to use multiple penetrometers in concert to detect and characterize subsurface features, leveraging direct, refracted, and reflected seismic waves for comprehensive underground mapping.

The local facility will use the local soil's seismic speed and attenuation characteristics to balance penetrometer spacing between finding small objects with closely spaced penetrometers or higher productivity that only finds larger objects with wider penetrometer spacing. By installing the penetrometers a significant distance apart (e.g., 25 meters), and using the hammer-induced and reflected seismic energy to locate subsurface anomalies, embodiments of the present disclosure can cover large areas quickly. For example, if a single UGV can install one penetrometer every 10 minutes, it can install approximately 49 penetrometers in an 8-hour shift. If the penetrometers are placed in a 7 by 7 matrix and spaced 25 meters apart, the included area would be 150 by 150-meters or 22,500 square meters. If the sensible area extends 12.5-meters beyond the edge of the included area, then the sensed area becomes 175 by 175-meters or 30,625 square meters. At that rate of inspection, a single system consisting of one local facility and five UGVs could inspect a site measuring one square kilometer in less than seven working shifts, or less than three days with operators relieved every 8 hours.

The system concept's scalability, the fact that a single local facility combined with a highly capable control station can control many relatively inexpensive UGVs, allows the system to expand as needed to address very large areas that may harbor hazardous objects. The merging of advanced robot management tools, e.g., algorithms for swarm path planning and replanning, to enhance the capabilities of the autonomous UGV robots decreases the operator-to-robot ratio and minimizes human operator labor. The system's use of retrievable and reusable penetrometers, i.e., those that are too far from the seismic stimulus to sense even the primary seismic energy or that no longer have sufficient battery power to function, reduces recurring costs.

The process begins with the penetrometers being inserted into the ground by uncrewed ground vehicles. These penetrometers serve a dual purpose: they act as both seismic sources and sensors. When a penetrometer is hammered into the ground, it generates high-frequency seismic waves that propagate through the surrounding soil. The seismic source elements in each penetrometer also produce seismic stimulus in focused directions and at specific frequencies. These waves interact with subsurface objects and structures, reflecting and refracting based on the properties of the materials they encounter.

The reflected/refracted high-frequency waves are then detected by the network of penetrometers deployed across the survey area. Each penetrometer is equipped with multiple types of sensors, including geophones, microphones, and accelerometers, all capable of detecting these high-frequency signals. The use of multiple sensor types and their strategic placement in various directions and at various depths allows for the capture of a rich dataset that includes information from different angles and perspectives.

The high-frequency nature of these waves provides several advantages. Firstly, it allows for better resolution of small objects and fine details in the subsurface, as the shorter wavelengths can interact with smaller features. Secondly, it enables more precise determination of object boundaries and characteristics. However, high-frequency waves also attenuate more rapidly in soil, which is why the system uses a dense network of sensors to ensure adequate coverage and signal strength.

The data collected from this network of high-frequency sensors is then transmitted to powerful computer systems for processing and analysis. Processing at the local facility identifies small potential threats using data fusion techniques to merge the data from multiple penetrometers. Advanced algorithms in the RAF fuse the data from multiple sensors and sensor types and use artificial intelligence and machine learning to create detailed 3D images of the subsurface. These images can reveal the presence, size, shape, and depth of buried objects with a level of detail not achievable with lower-frequency systems.

By leveraging the properties of high-frequency seismic waves and combining them with advanced sensing and data processing techniques, this system pushes the boundaries of what's possible in remote subsurface surveying, offering unprecedented insight into underground conditions across large areas.

FIG. 8 shows a distributed mesh architecture 700 according to an embodiment of the present disclosure. The system includes a plurality of penetrometers 712, 714, 716, 718, 720, 722, 724, each functioning as an autonomous computational node capable of peer-to-peer communication without requiring centralized coordination. Bidirectional communication links connect the penetrometers in a mesh configuration, with penetrometer 724 communicating with penetrometers 718 and 720; penetrometer 718 communicating with penetrometers 720 and 714; penetrometer 720 communicating with penetrometers 714, 712, and 716; and penetrometer 716 communicating with penetrometer 722. Each penetrometer broadcasts composite waveform data, including wave arrival time, amplitude, and temporal attenuation, along with its precise location to neighboring penetrometers. Upon receiving broadcasts from neighboring penetrometers, each penetrometer autonomously calculates seismic velocity and spatial attenuation coefficients between itself and its neighbors. This distributed approach enables the array to function as a self-organizing computational mesh where collective behavior emerges from peer interactions rather than central control. The penetrometer network collectively detects a subsurface anomaly 730 through the distributed seismic property calculations and discontinuity detection.

FIG. 9 shows a computing system 800 that is part of the penetrometer, local facility, RAF, and mobile unit for remote surveying. According to example embodiments shown schematically in FIG. 8, the computing system 800 includes a computing environment 810 and a communication unit 850. The computing environment 810 includes a processor 820, a memory 830, and an I/O interface 840. The computing environment 810 is coupled to the communication unit 850 through the I/O interface 840.

The processor 820 can typically control the overall operations of the computing environment 810, such as the operations associated with data acquisition, data processing, and data communications. The processor 820 can include one or more processors to execute instructions to perform all or some of the steps in the above-described methods. Moreover, the processor 820 can include one or more modules that facilitate the interaction between the processor 820 and other components. The processor may be or include a central processing unit (CPU), a microprocessor, a single chip machine, a graphical processing unit (GPU), System on a Chip (SoC), Tensor Processing Unit (TPU), Quantum Processor, Vision Processing Unit (VPU) or the like.

The memory 830 can store various types of data to support the operation of the computing environment 810. The Memory 830 can include predetermined software 831. Examples of such data comprise instructions for any applications or methods operated on the computing environment 810, financial data, user data, entity data, etc. The memory 430 may be implemented by using any type of volatile or non-volatile memory devices, or a combination thereof, such as a static random-access memory (SRAM), Dynamic Random-Access Memory (DRAM), an electrically erasable programmable read-only memory (EEPROM), an erasable programmable read-only memory (EPROM), a programmable read-only (PROM), an erasable programmable read-only memory (EPROM), a programmable read-only memory (PROM), a read-only memory (ROM), a magnetic memory, a flash memory, a magnetic or optical disk.

The I/O interface 840 can provide an interface between the processor 820 and peripheral interface modules, such as RF circuitry, external port, proximity sensor, audio and speaker circuitry, video and camera circuitry, microphone, accelerometer, display controller, optical sensor controller, intensity sensor controller, other input controllers, keyboard, a click wheel, buttons, Touchscreen Controller, Pressure Sensor, Light Emitting Diode (LED) Controller, Universal Serial Bus (USB) Controller, Serial Peripheral Interface (SPI) Bus Controller, Digital-to-Analog Converter (DAC), Analog-to-Digital Converter (ADC), Radio Frequency Identification (RFID) Reader/Writer and the like. The buttons may include but are not limited to, a home button, a power button, and volume buttons.

Communication unit 850 provides communication between the processing unit, an external device, mobile device, and a webserver (or cloud). The communication can be done through, for example, a mesh network, WIFI, or BLUETOOTH hardware protocols, Cellular Networks (4G LTE, 5G), NFC (Near Field Communication), Radio Frequency Identification (RFID), Satellite Communication, Ethernet or the like. The communication unit 860 can be within the computing environment or connected to it.

In one or more embodiments, the computing environment 810 can be coupled to a user interface that can include a speaker, lights, display, haptic feedback motor, Gesture Recognition System, Tactile Feedback Devices, Biometric Sensors, Voice Recognition System or other similar technologies for communicating with the user.

In some embodiments, there is also provided a non-transitory computer-readable storage medium comprising a plurality of programs, such as comprised in the memory 830, executable by the processor 820 in the computing environment 810, for performing the above-described methods. For example, the non-transitory computer-readable storage medium may be a ROM, a RAM, or the like.

The non-transitory computer-readable storage medium has stored therein a plurality of programs for execution by a computing device having one or more processors, where the plurality of programs for execution by a computing device having one or more processors, where the plurality of programs when executed by one or more processors, cause the computing device to perform the above-described method for motion prediction.

In some embodiments, the computing environment 810 may be implemented with one or more application-specific integrated circuits (ASICs), digital signal processors (DSPs) digital signal processing devices (DSPDs), programmable logic devices (PLDs), field-programmable gate arrays (FPGAs), graphical processing units (GPUs), controllers, micro-controllers, microprocessors, or other electronic components, for performing the above methods.

FIG. 10 shows an example method for high-frequency remote surveying in accordance with the present disclosure. The method can be applied to a system for high-frequency remote surveying that includes a plurality of penetrometers functioning as autonomous computational nodes capable of peer-to-peer communication.

In step 910, the remote surveying system deploys a plurality of penetrometers across a survey area, each penetrometer functioning as an autonomous computational node. The penetrometers may be deployed via mobile units such as uncrewed ground vehicles, uncrewed aerial vehicles, or manual installation depending on terrain conditions. Each penetrometer includes a seismic wave generator, sensors capable of detecting high-frequency seismic waves, and a control unit configured for peer-to-peer communication with other penetrometers in the network.

In step 912, the remote surveying system generates, at a source penetrometer, multiple seismic impacts at known times. The seismic wave generator, which may include an internal recoilless hammer, produces multiple hammer impacts at precisely known times using GPS-synchronized timing signals. This temporal oversampling approach enables statistical aggregation of sensor data to improve signal-to-noise ratios.

In step 914, the remote surveying system generates, at each receiving penetrometer, composite waveforms by statistically aggregating sensor data across the multiple seismic impacts. Sensor data from receiving penetrometers is time-aligned via the GPS-synchronized timing signals, and composite waveforms are generated locally at each penetrometer through statistical aggregation of sensor data across the multiple impact events. This dramatically improves the signal-to-noise ratio and enables detection of weak reflected signals that would otherwise be indistinguishable from background noise.

In step 916, the remote surveying system broadcasts, from each penetrometer, composite waveform data to other penetrometers via peer-to-peer communication. Each penetrometer broadcasts its composite waveform data, including wave arrival time, amplitude, and temporal attenuation, along with its precise location to other penetrometers in the network. This peer-to-peer communication enables the array to function as a self-organizing computational mesh without requiring centralized coordination.

In step 918, the remote surveying system autonomously calculates, at each penetrometer, seismic properties from data received from neighboring penetrometers. Upon receiving broadcasts from neighboring penetrometers, each penetrometer autonomously calculates seismic velocity and spatial attenuation coefficients between itself and its neighbors. This distributed computation approach provides fault tolerance and scalability, as the system continues operating despite loss of individual penetrometers.

In step 920, the remote surveying system builds a spatial map of seismic velocity and attenuation values across the survey area and identifies discontinuities as locations of interest. As the penetrometer array grows incrementally, the system identifies discontinuities where seismic velocity or attenuation between one penetrometer pair differs significantly from neighboring pairs. These discontinuities are flagged as locations of interest requiring closer inspection, as they may indicate the presence of voids, dense objects, disturbed soil, or layer boundaries.

In step 922, the remote surveying system generates a survey report based on the distributed seismic data. This report synthesizes the seismic property data from the distributed penetrometer network into actionable intelligence, including detailed subsurface maps, identified anomalies, and characterizations of geological features. Advanced algorithms, possibly incorporating artificial intelligence and machine learning techniques, analyze the seismic wave patterns, reflections, and refractions to construct a three-dimensional model of the subsurface. The report may include visualizations such as cross-sectional views, depth maps, and anomaly highlights, along with quantitative data on local seismic velocity and attenuation characteristics, and potential hazards like unexploded ordnance or voids.

In an embodiment, when the distributed penetrometer network detects an object of interest through seismic property discontinuities, the system can determine that additional, more detailed investigation is required. The system analyzes the seismic data and calculates optimal locations for deploying additional penetrometers closer to the detected anomaly. Additional penetrometers may be deployed to the calculated locations to conduct higher-resolution measurements. The resulting data is integrated with existing information through the peer-to-peer network to create a more comprehensive and detailed survey. This adaptive approach allows for dynamic, targeted investigation of subsurface anomalies, enhancing the system's ability to characterize and precisely locate objects such as unexploded ordnance or other significant geological features.

In one or more embodiments, the distributed penetrometer network employs sensor fusion techniques to merge data from multiple penetrometers, thereby improving threat detection thresholds and generating a comprehensive survey of the area. This process leverages the peer-to-peer communication capabilities of the penetrometer network to create a more accurate and detailed picture of subsurface anomalies without requiring centralized processing.

For instance, when one penetrometer generates seismic waves, the sensors on multiple penetrometers detect reflections and autonomously calculate seismic properties. Each penetrometer analyzes the received waveforms, considering factors such as wave arrival time, amplitude, and temporal attenuation. This multi-point data collection through the distributed network allows for advanced analysis techniques such as triangulation, distance estimation, and size estimation. For triangulation, by comparing arrival time data from multiple penetrometers, the system can estimate the general location of an anomaly. For distance estimation, using the locally calculated seismic velocity and precise signal reception times at each penetrometer, the system calculates distance estimates from each sensor to the anomaly. For size estimation, the reflected spectra at each penetrometer provide data for estimating the anomaly's size.

The distributed penetrometer network combines these analyses to generate a preliminary characterization of the detected anomaly. While individual penetrometers autonomously calculate seismic properties and broadcast composite waveform data, the collective network performs the more complex task of data fusion through peer-to-peer communication. This includes combining data to estimate size and location, and potentially commanding additional penetrometers to be deployed closer to a potential threat based on predefined rule systems.

As the precision of the distributed seismic measurements increases relative to the size of the artifact, more details emerge, allowing for increasingly sophisticated analysis. This approach can provide sufficient detail to differentiate between different types of subsurface objects, such as distinguishing a 155 mm cannon shell from an 81/82 mm mortar shell, especially after closer inspection enabled by adaptive deployment of additional penetrometers to the area of interest.

Multiple embodiments are described herein, including the best mode known to the inventors for practicing the claimed invention. Of these, variations of the disclosed embodiments will become apparent to those of ordinary skill in the art upon reading the foregoing disclosure. The inventors expect skilled artisans to employ such variations as appropriate (e.g., altering or combining features or embodiments), and the inventors intend for the invention to be practiced otherwise than as specifically described herein. In addition, while the invention has been described in terms of several preferred embodiments, it should be understood that there are many alterations, permutations, and equivalents that fall within the scope of this invention. It should also be noted that there are alternative ways of implementing both the process and apparatus of the present invention. For example, steps do not necessarily need to occur in the orders shown in the accompanying figures and may be rearranged as appropriate. It is therefore intended that the appended claim includes all such alterations, permutations, and equivalents as fall within the true spirit and scope of the present invention.

What is claimed is:

1. A system for high-frequency remote surveying comprising:
a plurality of penetrometers, each penetrometer functioning as an autonomous computational node and comprising:
a seismic wave generator configured to generate high-frequency seismic waves,
sensors capable of detecting the high-frequency seismic waves,
a control unit configured to broadcast composite waveform data to the plurality of penetrometers and calculate seismic properties from data received from neighboring penetrometers, and
a network configured to enable peer-to-peer communication between the plurality of penetrometers without requiring centralized coordination.

2. The system of claim 1, wherein the control unit is configured to generate composite waveforms by statistically aggregating sensor data across multiple seismic impact events to improve signal-to-noise ratio.

3. The system of claim 1, wherein each penetrometer is configured to broadcast composite waveform data comprising wave arrival time, amplitude, frequency content, and location to other penetrometers in the network.

4. The system of claim 1, wherein the control unit is configured to autonomously calculate seismic propagation velocity and spatial attenuation coefficients from data received from neighboring penetrometers.

5. The system of claim 1, wherein each penetrometer is configured to autonomously command a source penetrometer to generate additional seismic impacts based on signal-to-noise ratio assessment.

6. The system of claim 1, wherein the system is configured to continue operating despite loss of individual penetrometers.

7. The system of claim 1, wherein each penetrometer comprises a sensor sampled at a rate from approximately 1 Hz up to approximately 60,000 Hz, the rate being selected to satisfy a Nyquist criterion for the highest frequency of interest in the seismic waves, and the seismic waves detected by the sensor comprise frequency content from approximately 10 Hz to approximately 2,000 Hz.

8. The system of claim 1, wherein the seismic wave generator comprises an internal recoilless hammer.

9. The system of claim 1, wherein each penetrometer further comprises a global navigation satellite system (GNSS) receiver for precise timing and location.

10. A method for high-frequency remote surveying comprising:
deploying a plurality of penetrometers across a survey area, each penetrometer functioning as an autonomous computational node;
generating, at a seismic source, multiple seismic impacts at known times;
generating, at each receiving penetrometer, composite waveforms by statistically aggregating sensor data across the multiple seismic impacts;
broadcasting, from each penetrometer, composite waveform data to other penetrometers via peer-to-peer communication; and
autonomously calculating, at each penetrometer, seismic properties from data received from neighboring penetrometers.

11. The method of claim 10, wherein generating composite waveforms comprises aggregating sensor data across a plurality of seismic impacts to improve signal-to-noise ratio.

12. The method of claim 10, further comprising autonomously commanding, by a receiving penetrometer, the source penetrometer to generate additional seismic impacts based on signal-to-noise ratio assessment.

13. The method of claim 10, further comprising:
building a spatial map of seismic velocity and attenuation values across the survey area; and
identifying discontinuities where seismic properties between one penetrometer pair differ from neighboring pairs as locations of interest.

14. The method of claim 10, further comprising detecting multiple wave types including a first wave type having a first dominant wavelength for detection of objects of a first size scale comparable to or smaller than the first dominant wavelength, and a second wave type having a second dominant wavelength longer than the first dominant wavelength for detection of objects of a second size scale comparable to or larger than the first size scale.

15. The method of claim 10, wherein deploying the plurality of penetrometers comprises deploying via at least one of aerial vehicle delivery, ground vehicle placement, or manual installation.

16. The method of claim 10, further comprising continuously recalculating seismic propagation velocity, frequency content, and attenuation coefficients as new penetrometers are added to the survey area and dynamically adapting penetrometer spacing based on updated measurements.

17. The method of claim 10, wherein the plurality of penetrometers continue operating despite loss of individual penetrometers.

18. The method of claim 10, wherein autonomously calculating seismic properties achieves seismic propagation velocity precision sufficient to detect anomalies smaller than natural soil heterogeneity variations through temporal oversampling and measurements from multiple penetrometer pairs.

19. A method for high-frequency remote surveying comprising:
deploying a plurality of penetrometers across a survey area, each penetrometer comprising a seismic wave generator and sensors;
generating, at a source penetrometer, multiple seismic impacts at known times using GPS-synchronized timing;
time-aligning, at each receiving penetrometer, sensor data from the multiple seismic impacts using the GPS-synchronized timing;
statistically aggregating the time-aligned sensor data to generate composite waveforms with improved signal-to-noise ratio;
extracting parameters from the composite waveforms, the parameters comprising wave arrival time, amplitude, frequency content, and temporal attenuation; and
transmitting the extracted parameters rather than raw sensor data to avoid bandwidth bottlenecks when scaling to large numbers of penetrometers.

20. The method of claim 19, wherein statistically aggregating comprises aggregating sensor data across a plurality of seismic impacts to achieve improved arrival time precision, enabling detection of subsurface anomalies smaller than natural soil heterogeneity variations.

21. A penetrometer for high-frequency remote surveying comprising:
a housing;
a seismic wave generator comprising an internal recoilless hammer configured to generate high-frequency seismic waves;
sensors capable of detecting the high-frequency seismic waves, the sensors comprising at least one of an accelerometer, a geophone, or a microphone;
a global navigation satellite system (GNSS) receiver configured to provide precise timing and location;
a control unit configured to generate composite waveforms by statistically aggregating sensor data across multiple seismic impacts, calculate seismic properties, and communicate with other penetrometers via peer-to-peer communication; and
a battery for powering the penetrometer.
